(19) United States
(12) Patent Application Publication
(10) Pub. No.: US 2026/0319839 A1
(43) Pub. Date: Oct. 15, 2026

(54) METHOD, APPARATUS, DEVICE FOR TASK PROCESSING AND STORAGE MEDIUM

(71) Applicants: Beijing Zitiao Network Technology Co., Ltd., Beijing (CN); Lemon Inc., Grand Cayman (KY)

(72) Inventors: Junyuan QI, Beijing (CN); Chen FU, Los Angeles, CA (US); Xin ZHONG, Beijing (CN); Xing Li, Los Angeles, CA (US); Qinxian XIA, Beijing (CN); Bowen SHEN, Beijing (CN)

(21) Appl. No.: 19/686,448

(22) Filed: May 22, 2026

Related U.S. Application Data
(63) Continuation of application No. PCT/CN2024/131401, filed on Nov. 11, 2024.
(63) Continuation of application No. PCT/CN2024/131403, filed on Nov. 11, 2024.

(30) Foreign Application Priority Data
Nov. 22, 2023 (CN) 202311569258.9
Nov. 22, 2023 (CN) 202311569293.0

(51) Int. Cl. G06F 9/48

(52) U.S. Cl. CPC G06F 9/4881

(57) ABSTRACT

According to embodiments of the disclosure, task processing method, apparatus, device and storage medium are provided. In the method for task processing, detecting whether execution conditions of respective work nodes in a first workflow are satisfied, where the first workflow comprises a plurality of work nodes; obtaining information related to a first work node in the first workflow in response to detecting that an execution condition of the first work node is satisfied; determining at least one task to be executed based on the information related to the first work node; and executing at least a part of the at least one task, and/or assigning at least a part of the at least one task to a target execution body.

### CROSS-REFERENCE

This application is a continuation of both International Patent Application No. PCT/CN2024/131401, filed on Nov. 11, 2024, which claims priority to Chinese Patent Application No. 202311569258.9, filed on Nov. 22, 2023, and entitled “METHOD, APPARATUS, DEVICE FOR TASK PROCESSING AND STORAGE MEDIUM” and International Patent Application No. PCT/CN2024/131403, filed on Nov. 11, 2024, which claims priority to Chinese Patent Application No. 202311569293.0, filed on Nov. 22, 2023, and entitled “METHOD, APPARATUS, DEVICE FOR TASK PROCESSING AND STORAGE MEDIUM”, the contents of which are incorporated herein by reference in their entireties.

### TECHNICAL FIELD

Example embodiments of the present disclosure generally relate to the field of computers, and in particular, to a method, an apparatus, a device, and a computer-readable storage medium for task processing.

### BACKGROUND

With the rapid development of Internet technologies, the Internet has become an important platform for people to obtain and share content, and users may access the Internet through terminal devices to enjoy various Internet services. The terminal device presents corresponding content through a user interface of an application or a service component, and implements interaction with a user and provides services for the user. Therefore, the diverse interactive interfaces of applications are important means to improve user experience. With the development of information technologies, various terminal devices may provide with various services for people in work and life. For example, an application providing services may be deployed in the terminal device. The terminal device or the application may provide the user with a digital assistant-like function to assist the user in using the terminal device or the application. How to improve the flexibility of interaction between the user and the digital assistant is a technical issue to be explored.

### SUMMARY

In a first aspect of the present disclosure, a method for task processing is provided. The method includes: detecting whether execution conditions of respective work nodes in a first workflow are satisfied, where the first workflow includes a plurality of work nodes; in response to detecting that an execution condition of a first work node in the first workflow is satisfied, obtaining information related to the first work node; determining at least one task to be executed based on the information related to the first work node; and executing at least a part of the at least one task, and/or assigning at least a part of the at least one task to a target execution body.

In a second aspect of the present disclosure, a method for task processing is provided. The method includes: detecting whether a task trigger condition related to a first digital assistant is satisfied; and in response to the task trigger condition being satisfied, initiating task execution related to the first digital assistant. The task execution includes: obtaining information related to a first task; and performing, by interacting with a target model, at least one of the following based on the obtained information related to the first task: obtaining attribute information of the first task; executing the first task based on the attribute information of the first task.

In a third aspect of the present disclosure, an apparatus for task processing is provided. The apparatus includes: an execution condition detection module configured to detect whether execution conditions of respective work nodes in a first workflow are satisfied, where the first workflow includes a plurality of work nodes; a related information obtaining module configured to obtain information related to a first work node in the first workflow in response to detecting that an execution condition of the first work nod is satisfied; a task determination module configured to determine at least one task to be executed based on the information related to the first work node; and a task processing module configured to execute at least a part of the at least one task, and/or assign at least a part of the at least one task to a target execution body.

In a fourth aspect of the present disclosure, an apparatus for task processing is provided. The apparatus includes: a trigger detection module configured to detect whether a task trigger condition related to a first digital assistant is satisfied; and a task execution module configured to initiate task execution related to the first digital assistant in response to the task trigger condition being satisfied. The task execution includes: obtaining information related to a first task; and performing, by interacting with a target model, at least one of the following based on the obtained information related to the first task: obtaining attribute information of the first task; executing the first task based on the attribute information of the first task.

In a fifth aspect of the present disclosure, an electronic device is provided. The electronic device includes at least one processor; and at least one memory coupled to the at least one processor and storing instructions executable by the at least one processor. The instructions, when executed by the at least one processor, cause the electronic device to perform the method of the first aspect and/or the method of the second aspect.

In a sixth aspect of the present disclosure, a non-transitory computer-readable storage medium is provided. The non-transitory computer-readable storage medium stores a computer program, the computer program being executable by a processor to implement the method of the first aspect and/or the method of the second aspect.

In a seventh aspect of the present disclosure, a computer program product is provided. The computer program product is tangibly stored in a computer storage medium and includes computer-executable instructions, the computer-executable instructions, when executed by a device, causing the device to perform the method of the first aspect and/or the method of the second aspect.

It should be understood that the content described in this section is not intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the drawings and with reference to the following detailed description. In the drawings, the same or similar reference numbers refer to the same or similar elements, where:

FIG. 1 illustrates a schematic diagram of an example environment in which the embodiments of the present disclosure may be implemented;

FIG. 2 illustrates a flowchart of a process for task processing according to some embodiments of the present disclosure;

FIG. 3 illustrates a flowchart of a process for task processing according to some other embodiments of the present disclosure;

FIG. 4A illustrates a flowchart of a process for task processing according to some other embodiments of the present disclosure;

FIG. 4B illustrates a flowchart of a process for task processing according to some other embodiments of the present disclosure;

FIG. 4C illustrates a flowchart of a process for task processing according to some other embodiments of the present disclosure;

FIG. 5 illustrates a block diagram of an apparatus for task processing according to some embodiments of the present disclosure;

FIG. 6 illustrates a block diagram of an apparatus for task processing according to some embodiments of the present disclosure;

FIG. 7 illustrates a block diagram of an apparatus for task processing according to some embodiments of the present disclosure;

FIG. 8 illustrates a block diagram of an apparatus for task processing according to some other embodiments of the present disclosure;

FIG. 9A illustrates a block diagram of an apparatus for task processing according to some other embodiments of the present disclosure;

FIG. 9B illustrates a block diagram of an apparatus for task processing according to some other embodiments of the present disclosure;

FIG. 9C illustrates a block diagram of an apparatus for task processing according to some other embodiments of the present disclosure; and

FIG. 10 illustrates a block diagram of an electronic device in which one or more embodiments of the present disclosure may be implemented.

### DETAILED DESCRIPTION OF EMBODIMENTS

The embodiments of the present disclosure will be described in more detail below with reference to the drawings. Although certain embodiments of the present disclosure are shown in the drawings, it should be understood that the present disclosure may be implemented in various forms and should not be construed as limited to the embodiments set forth herein. On the contrary, these embodiments are provided for a more thorough and complete understanding of the present disclosure. It should be understood that the drawings and embodiments of the present disclosure are only used for illustrative purposes, and are not used to limit the protection scope of the present disclosure.

In the description of the embodiments of the present disclosure, the term “include/comprise” and similar terms thereof should be understood as open-ended inclusions, that is, “include/comprise but not limited to”. The term “based on” should be understood as “at least partially based on”. The term “one embodiment” or “the embodiment” should be understood as “at least one embodiment”. The term “some embodiments” should be understood as “at least some embodiments”. The following may also include other explicit and implicit definitions.

Herein, unless explicitly stated, performing a step “in response to A” does not mean that the step is performed immediately after “A”, but may include one or more intermediate steps.

It is to be understood that the data involved in the technical solution (including but not limited to the data itself, acquisition, use, storage or deletion of the data) should comply with requirements of corresponding laws, regulations and related provisions.

It is to be understood that before adopting the technical solutions disclosed in the embodiments of the present disclosure, the relevant users should be informed of the type, range of use, use scenarios, etc. of the information involved in the present disclosure and obtain authorization from the relevant users in an appropriate manner in accordance with relevant laws and regulations, where the relevant users may include any type of subject of rights, such as individuals, enterprises, groups.

For example, in response to receiving an active request from a user, prompt information is sent to the relevant user to clearly prompt the relevant user that the requested operation will require access to and use of information of the relevant user, so that the relevant user may independently choose, based on the prompt information, whether to provide the information to software or hardware, such as an electronic device, an application, a server, or a storage medium, that performs the operations of the technical solutions of the present disclosure.

As an optional but non-limiting implementation, in response to receiving the active request from the relevant user, the prompt information may be sent to the relevant user in the form of, for example, a pop-up window, in which the prompt information may be presented in text. In addition, the pop-up window may also include a selection control for the user to choose whether to “agree” or “disagree” to provide the information to the electronic device.

It is to be understood that the above process of notifying and obtaining user authorization is only illustrative and does not limit the implementations of the present disclosure, and other manners that satisfy the relevant laws and regulations may also be applied in the implementations of the present disclosure. The enabling of the functions related to the digital assistant, the data acquired, the manner of processing and storing the data, etc. in the embodiments of the present disclosure should all be authorized in advance by the user and other subjects of rights associated with the user, and should comply with the relevant laws, regulations and the agreements and rules between the subjects of rights.

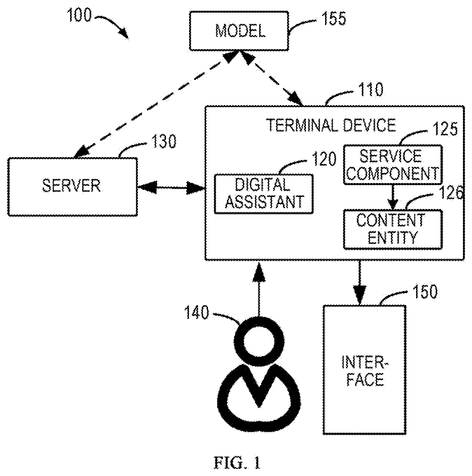

FIG. 1 illustrates a schematic diagram of an example environment 100 in which the embodiments of the present disclosure can be implemented. In this example environment 100, a digital assistant 120 and a service component 125 are installed on a terminal device 110. A user 140 may interact with the digital assistant 120 and the service component 125 via the terminal device 110 and/or an attachment device of the terminal device 110.

In some embodiments, the digital assistant 120 and the service component 125 may be downloaded and installed on the terminal device 110. In some embodiments, the digital assistant 120 and the service component 125 may also be accessed in other manners, such as via web page. In the environment 100 of FIG. 1, in response to the service component 125 being launched, the terminal device 110 may present an interface 150 of the digital assistant 120 and the service component 125.

The service component 125 includes, but is not limited to, one or more of the following: a chat component (also referred to as an instant messaging component), a document component, an audio and video conference component, an email component, a task component, a calendar component, an objective and key results (OKR) component, and the like. It may be understood that although a single service component is shown in FIG. 1, in practice, a plurality of service components may be installed on the terminal device 110. In some embodiments, the service component 125 may include a multi-functional collaboration platform, for example, an office collaboration platform (also referred to as an office suite) that can provide an integration of multiple types of service components to facilitate people's activities such as office work and communication. In the multi-functional collaboration platform, people may launch different service components as needed to complete corresponding information processing, sharing, communication, etc. The service component 125 may provide a content entity 126. The content entity 126 may be a content instance created by the user 140 or other users on the service component 125. For example, depending on the type of the service component 125, the content entity 126 may be a document (e.g., a word document, a pdf document, a presentation, a table document, etc.), an email, a message (e.g., a chat message on the instant messaging component or a message on other components), a calendar, a schedule, a task, an audio, a video, an image, and so on.

In some embodiments, the digital assistant 120 may be provided by a separate service component, or may be integrated into a certain service component 120 that can provide the content entity. The service component for providing the client interface of the digital assistant may correspond to a single-function service component or a multi-functional collaboration platform, such as an office suite or other collaboration platforms that can integrate multiple components. It is to be understood that, similar to the service component, although a single digital assistant is shown in FIG. 1, there may actually be multiple digital assistants.

In some embodiments, the digital assistant 120 supports the use of plugins. Each plugin may provide one or more functions of an application. Such plugins include, but are not limited to, one or more of the following: a search plugin, a contact plugin, a message plugin, a document plugin, a table plugin, an email plugin, a calendar plugin, a schedule plugin, a task plugin, and the like.

The digital assistant 120 is an intelligent assistant of a user, and has intelligent conversation and information processing capabilities. In the embodiments of the present disclosure, the digital assistant 120 is configured to interact with the user 140 to assist the user 140 in using the terminal device or an application. An interaction window with the digital assistant 120 may be presented in the client interface. In the interaction window, the user 140 may talk to the digital assistant 120 by inputting a natural language, a picture, an audio file, a video file, a web page file, etc., to instruct the digital assistant to assist in completing various tasks, including operations on the content entity 126.

In some embodiments, the digital assistant 120 may be included in a contact list of the current user 140 in the office suite, or included in an information flow of the chat component, as a contact of the user 140. In some embodiments, the user 140 has a correspondence with the digital assistant 120. For example, a first digital assistant corresponds to a first user, a second digital assistant corresponds to a second user, and so on. In some embodiments, the first digital assistant may uniquely correspond to the first user, the second digital assistant may uniquely correspond to the second user, and so on. That is, the first digital assistant of the first user may be specific or exclusive to the first user. For example, in a process in which the first digital assistant provides assistance or service for the first user, the first digital assistant may utilize historical interaction information between the first digital assistant and the first user, data authorized by the first user that the first digital assistant can access, a current interaction context between the first digital assistant and the first user, etc. If the first user is an individual or a person, the first digital assistant may be regarded as a personal digital assistant. It may be understood that in the disclosed embodiments, the first digital assistant accesses the data granted permission based on the authorization of the first user. It should be understood that the “unique correspondence” or similar expressions in the present disclosure are not intended to limit that the first digital assistant will be updated accordingly based on an interaction process between the first user and the first digital assistant. Certainly, depending on actual application needs, the digital assistant 120 is not necessarily specific to the current user 140, but may be a universal digital assistant.

In some embodiments, during a running process of the digital assistant 120 and/or the service component 125, one or more models 155 may be invoked to perform task processing. For example, the digital assistant 120 may utilize the model 155 to help understand the user input, and provide a reply to the user based on the output of the model 155. In some embodiments, the model may be a machine learning model, a deep learning model, a learning model, a neural network, etc. In some embodiments, the model may be based on a language model (LM). The language model may have question answering capabilities by learning from a large amount of corpus. The model may also be based on other appropriate models. Although shown as being independent of the server and/or the terminal device, the one or more models 155 may run on the server and/or the terminal device, or other remote servers.

In some embodiments, a plurality of interaction modes between the user 140 and the digital assistant 120 may be provided, and flexible switching between the plurality of interaction modes is allowed. In a case where a certain interaction mode is triggered, a corresponding interaction region is presented to facilitate the interaction between the user 140 and the digital assistant 120. Interaction manners between the user 140 and the digital assistant 120 in different interaction modes are different, so that the interaction needs in different application scenarios may be flexibly adapted.

In some embodiments, an information processing service specific to the user 140 may be provided based on historical interaction information between the user 140 and the digital assistant 120 and/or a data scope specific to the user 140. In some embodiments, historical interaction information of the user 140 interacting with the digital assistant 120 in a plurality of interaction modes, respectively, may all be stored in association with the user 140. In this way, in one (any or a designated one) of the plurality of interaction modes, the digital assistant 120 may provide a service for the user 140 based on the historical interaction information stored in association with the user 140.

The digital assistant 120 may be invoked or woken up in an appropriate manner (for example, a shortcut key, a button, or a voice) to present an interaction window with the user 140. By selecting the digital assistant 120, the interaction window with the digital assistant 120 may be launched. The interaction window may include interface elements for information exchange, such as an input box, a message list, a message bubble, and the like. In some other embodiments, the digital assistant 120 may be invoked through an entry control or a menu provided in a page, or may be invoked by inputting a preset instruction.

The interaction window between the digital assistant 120 and the user 140 may include a chat window, such as a chat window in an instant messaging application or an instant messaging module of a specific application. In the chat window, the interaction between the digital assistant 120 and the user 140 may be presented in the form of chat messages. Alternatively or additionally, the interaction window between the digital assistant 120 and the user 140 may further include other types of windows, such as a window in a floating window mode, in which the user 140 may trigger the digital assistant 120 to perform corresponding operations by inputting instructions, selecting quick instructions, etc.

In some embodiments, the digital assistant 120 may support an interaction mode of the chat window, which may also be referred to as a chat mode. In this interaction mode, a chat window of the user 140 and the digital assistant 120 is presented, and in the chat window, the user 140 and the digital assistant 120 interact through chat messages. In the chat mode, the digital assistant 120 may perform tasks according to the chat messages in the chat window. In the interaction window, the user 140 inputs an interaction message, and the digital assistant 120 provides a reply message in response to the user input.

In some embodiments, the chat mode between the user 140 and the digital assistant 120 may be invoked or woken up in an appropriate manner (for example, a shortcut key, a button, or a voice) to present a chat window. By selecting the digital assistant 120, the chat window with the digital assistant 120 may be launched. The chat window may include interface elements for information exchange, such as an input box, a message list, a message bubble, and the like.

In some embodiments, the digital assistant 120 may support an interaction mode of a floating window (or floating windows), which may also be referred to as a floating window mode. In a case where the floating window mode is triggered, an operation panel (also referred to as a floating window) corresponding to the digital assistant 120 is presented, and the user 140 may issue instructions to the digital assistant 120 based on the operation panel. In some embodiments, the operation panel may include at least one candidate quick instruction. Alternatively or additionally, the operation panel may include an input control for receiving instructions. In the floating window mode, the digital assistant 120 may perform tasks according to instructions issued by the user 140 through the operation panel.

In some embodiments, the floating window mode between the user 140 and the digital assistant 120 may also be invoked or woken up in an appropriate manner (for example, a shortcut key, a button, or a voice) to present the corresponding operation panel. In some embodiments, in a specific application, for example, in a document application, the digital assistant 120 may be supported to wake up to provide interaction in the floating window mode. In some embodiments, in order to trigger the floating window mode to present the operation panel corresponding to the digital assistant 120, an entry control for the digital assistant 120 may be presented in the application interface. In response to detecting a trigger operation on the entry control, it may be determined that the floating window mode is triggered, and the operation panel corresponding to the digital assistant 120 is presented in a target interface region.

In some embodiments described below, for the convenience of discussion, the case where the interaction window between the user and the digital assistant is a chat window is mainly taken as an example for description.

In some embodiments, the terminal device 110 communicates with the server 130 to implement the provision of services for the digital assistant 120 and the service component 125. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a television receiver, a radio broadcast receiver, an e-book device, a game device, or any combination of the above, including accessories and peripherals of these devices or any combination thereof. In some embodiments, the terminal device 110 may also support any type of user-specific interface (such as “wearable” circuitry, etc.). The server 130 may be various types of computing systems/servers that can provide computing power, including but not limited to mainframes, edge computing nodes, computing devices in cloud environments, and so on.

It should be understood that the structures and functions of the various elements in the environment 100 are described only for the purpose of illustration, without suggesting any limitation on the scope of the present disclosure.

As briefly mentioned above, the digital assistant may assist the user in using the terminal device or the application. Some applications may provide an integration function of different plugins. In addition to free conversations with the digital assistant, the user may also use instructions such as a natural language to enable the digital assistant to use different plugins to complete some more complex operations related to the service of the application, such as creating documents, scheduling appointments, creating tasks, etc. Traditionally, the user often needs to proactively trigger interaction with the digital assistant, and the digital assistant relies on the instructions of the user to perform tasks. However, such a task execution manner always requires the user's immediate instructions, and tasks that the user has not discovered or noticed in time may not be able to immediately trigger the digital assistant to help execute. In some cases, for a digital assistant bound to a specific service component, service scenario, or user, the digital assistant usually may only perform information processing based on the immediate instructions of the service component, service scenario, or the user, and cannot effectively use the digital assistant to improve information processing efficiency in some special scenarios, for example, in a case where multiple service components need to cooperate, or the service scenario is relatively complex, or the user has difficulty giving immediate instructions in real time, the information processing efficiency is low; where, the service component may be different service components integrated in a collaboration platform, or a first service component accessing the collaboration platform, or a second service component associated with the user, and the first service component is usually allowed to perform a certain type or scope of information exchange with the service components in the collaboration platform or users of the platform, and the second service component is a service component registered or used by the user. In some other cases, a unified and standardized interaction experience is usually provided, which often cannot meet the individual needs of all users. The above various problems will affect the interaction efficiency and experience between the user and the digital assistant, and make the interaction function of the digital assistant not flexible enough.

According to some embodiments of the present disclosure, an improved solution for task processing is proposed, which aims to solve at least one of the above technical problems. In the embodiments of the present disclosure, it is detected whether execution conditions of respective work nodes in a first workflow are satisfied, where the first workflow includes a plurality of work nodes. In response to detecting that an execution condition of a first work node in the first workflow is satisfied, information related to the first work node is obtained. At least one task to be executed is determined based on the information related to the first work node. At least a part of the at least one task is executed, and/or at least a part of the at least one task is assigned to a target execution body. In this way, the intelligence, autonomy and flexibility of the digital assistant are improved, and the work efficiency in each service scenario is improved.

According to some embodiments of the present disclosure, an improved solution for task processing is proposed, which aims at solving at least one of the above technical problems. In this solution, whether a task trigger condition related to a first digital assistant is satisfied is detected; and task execution related to the first digital assistant is initiated in response to the task trigger condition being satisfied. The task execution includes: obtaining information related to a first task; performing, by interacting with a target model, at least one of the following based on the obtained information related to the first task: obtaining attribute information of the first task; executing the first task based on the attribute information of the first task. In this way, the intelligence of the digital assistant, the flexibility of the digital assistant, and the work efficiency based on the digital assistant are improved.

Some example embodiments of the present disclosure will be described in detail below with reference to examples in the drawings.

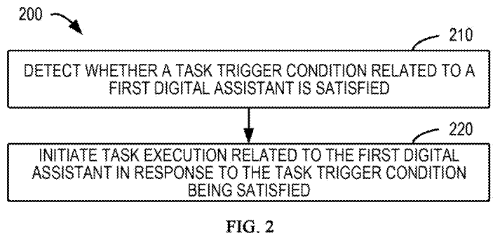

FIG. 2 illustrates a flowchart of a process 200 of task processing according to some embodiments of the present disclosure. For the convenience of discussion, the process 200 will be described with reference to the environment 100 in FIG. 1. The process 200 may be implemented at the terminal device 110 and/or the server 130. For the convenience of description, an example in which the process 200 is implemented at the terminal device 110 is used as an example below. It should be understood that some operations described with reference to the terminal device 110 may require the assistance of the server 130 to complete. It should be noted that the operations performed by the terminal device 110 may specifically be performed by a related application and/or a digital assistant installed on the terminal device 110.

At block 210, the terminal device 110 or the first digital assistant on the terminal device 110 detects whether a task trigger condition related to the first digital assistant is satisfied.

The terminal device 110 may obtain the task trigger condition related to the first digital assistant, which may be, for example, the digital assistant 120. It may be understood that the first digital assistant corresponds to a first user, and the first user may include one or more users, that is, the first digital assistant may be a personal assistant, a team assistant/an organizational assistant, etc. In some embodiments, the task trigger condition may be set by the first user (that is, the user 140 corresponding to the terminal device 110, which may also be referred to as the current user) corresponding to the first digital assistant.

Specifically, the terminal device 110 may receive at least one user input of the first user to the first digital assistant. The terminal device 110 may receive the at least one user input of the first user to the first digital assistant in a chat window between the first user and the first digital assistant, for example. The user input may be any type of input, such as text, audio, image, etc. The terminal device 110 may determine the task trigger condition based on the at least one user input. The terminal device 110 may analyze the user input to determine the task trigger condition indicated by the user input, for example. In an example, the first user may send a chat message “Remind me and prepare a reply email whenever I receive a customer complaint email” in the interaction window between the first user and the first digital assistant in advance. The terminal device 110 may determine that the task trigger condition is “receiving a customer complaint email” in response to receiving the chat message. Alternatively or additionally, the task trigger condition may also be determined by the terminal device 110 on its own. For example, the terminal device 110 may determine the task trigger condition based on historical data associated with the first user.

In some embodiments, the terminal device 110 may determine the task trigger condition by using a target model (such as the model 155 in FIG. 1). The terminal device 110 may construct a prompt input based on the at least one user input/historical data, for example. The terminal device 110 may provide the prompt input to the model 155 and obtain the task trigger condition determined by the model 155. In some embodiments, the model may be a machine learning model, a deep learning model, a learning model, a neural network, etc. In some embodiments, the model may be based on a language model (LM). The language model may obtain a question answering capability by learning from a large corpus. The model may also be based on other appropriate models.

The task trigger condition may include, for example, that the first user receives a notification message from a first service component. The first service component here may be, for example, a service component integrated with the first digital assistant. In this case, the terminal device 110 may determine that the task trigger condition related to the first digital assistant is satisfied in response to detecting the notification information from the first service component. The notification message here may be a notification message of the service component itself, or may be a notification message sent by a contact in the service component. In some embodiments, when setting a task, the first user may instruct the first digital assistant to detect the notification message of the first service component. In some embodiments, when setting a task, the user may also limit a type of the notification message. In this case, the terminal device 110 may determine that the task trigger condition related to the first digital assistant is satisfied in response to detecting the notification information of a predetermined type from the first service component.

The task trigger condition may also include, for example, that an event related to the first user occurs in a second service component. The second service component here may be the same service component as the first service component, or may be a different service component from the first service component. The event related to the first user here may also be any appropriate event, such as a calendar event associated with the first user, a time change event, a message notification event, a document change event, an email sending and receiving event, a task update event, etc. When setting a task, the first user may instruct the first digital assistant about the second service component to be detected and the event to be detected in the second service component. In some embodiments, if the second service component is a different service component from the first service component, in order to be able to obtain the event related to the first user occurring in the second service component, the terminal device 110 may provide a service component program interface (API) and a development interface to enable the second service component to register at the first digital assistant. The first digital assistant, for example, may only obtain data of a registered second service component.

The task trigger condition may also include, for example, that a preset time is reached. A task related to the arrival of the preset event may be referred to as a scheduled task. In this case, the terminal device 110 may determine that the task trigger condition related to the first digital assistant is satisfied in response to the current time reaching the preset time.

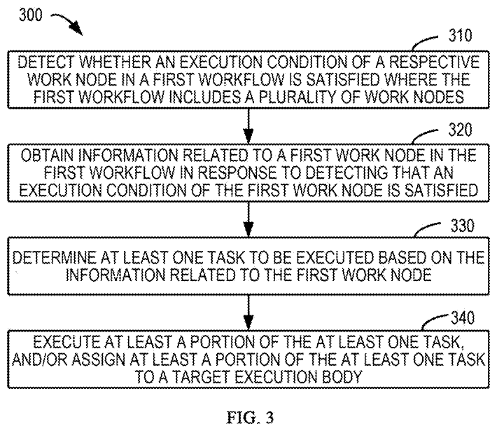

The task trigger condition may also include, for example, that an execution condition of one or more work nodes in a preset workflow is satisfied. In some embodiments, the task trigger conditions for triggering the first digital assistant to proactively execute the task may include that execution conditions of one or more work nodes in a first workflow are satisfied. The preset workflow here may include a plurality of work nodes. The plurality of work nodes respectively has one or more corresponding tasks, and there is a dependency relationship between tasks corresponding to two or more of the plurality of work nodes. For example, if a first node and a second node are adjacent nodes, and the first node is located before the second node, the second node may execute a task corresponding to the second node only if the first node completes a task corresponding to the first node. In this case, the terminal device 110 may determine that the task trigger condition related to the first digital assistant is satisfied and execute one or more tasks corresponding to a work node, for example, in response to detecting that an execution condition of the work node is satisfied. An embodiment of active task execution based on the preset workflow will be described in detail below with reference to FIG. 3.

It may be understood that some example task trigger conditions are discussed above, and in some embodiments, the task trigger condition of a certain task may also include a combination of one or more of the first user receiving the notification message from the first service component, the event related to the first user occurring in the second service component, the preset time being reached, the execution condition of the one or more work nodes in the preset workflow being satisfied, etc. For example, the task trigger condition may include that the preset time is reached, and the first user receives the notification message from the first service component. It may be understood that the task trigger condition may also include any appropriate condition, which is not limited to the embodiments of the present disclosure. The number of task trigger conditions related to the first digital assistant may depend on the setting of the first user for the first digital assistant, and different task trigger conditions may trigger the execution of one or more tasks.

In some embodiments, before detecting whether the task trigger condition is satisfied, the terminal device 110 may also determine whether an active task execution function of the first digital assistant is enabled. If it is determined that the active task execution function is enabled, the terminal device 110 may determine that the first digital assistant may perform detection of the task trigger condition, and detect whether the task trigger condition related to the first digital assistant is satisfied. If it is determined that the active task execution function is not enabled, the terminal device 110 may determine that the detection of the task trigger condition cannot be performed, that is, the terminal device 110 will not detect whether the task trigger condition related to the first digital assistant is satisfied. In some embodiments, if it is determined that the active task execution function is not enabled, the terminal device 110 may also provide a prompt message to the first user to prompt that the active task execution function of the first digital assistant is not currently enabled. In an example, the terminal device 110 may present the prompt message in a client interface of the digital assistant (e.g., the client interface presented by the terminal device 110). Regarding the manner of enabling the active task execution function of the first digital assistant, in some embodiments, the terminal device 110 may present a configuration page for configuring the first digital assistant. The configuration page, for example, may include an operation control for enabling the active task execution function. The terminal device 110 may determine to enable the active task execution function of the first digital assistant in response to detecting a trigger operation for the operation control. The server 130 may determine that the active task execution function of the first digital assistant is enabled through communication with the terminal device 110.

It should be noted that the enabling of the active task execution function of the digital assistant, the obtained data, the data processing and storage methods, etc. in the embodiments of the present disclosure shall be authorized in advance by the user and other subjects of rights associated with the user, and shall comply with the provisions of the relevant laws, regulations and agreement rules between the subjects of rights. In addition, the digital assistant proactively executes related tasks within the authorization scope of the user.

In some embodiments, the terminal device 110 may continuously detect whether one or more task trigger conditions related to the first digital assistant are satisfied. In some embodiments, the terminal device 110 may detect whether the task trigger condition is satisfied by using a target model (e.g., the model 155). In some embodiments, considering the resource and time overhead of model calling, the terminal device 110 may use different detection modes to detect whether the task trigger condition is satisfied.

In some embodiments, the terminal device 110 may detect whether the task trigger condition is satisfied based on a first detection mode, where the first detection mode includes a detection mode other than the interaction with the target model. In some examples, the first detection mode may include performing a key information search for first information, the first information including information for detecting whether the task trigger condition is satisfied. For example, at least one keyword associated with the task trigger condition may be acquired. The at least one keyword may be determined by the first user, or may be determined by the terminal device 110 on its own based on the task trigger condition. The terminal device 110 may then search, based on a keyword detection manner, whether the first information includes one or more keywords associated with the task trigger condition, thereby detecting whether the task trigger condition related to the first digital assistant is satisfied. In some embodiments, alternatively or additionally, the first detection mode further includes detecting whether the first information satisfies a preset rule. If the first information satisfies the preset rule, it may be determined that the task trigger condition related to the first digital assistant is satisfied. That is, in the first detection mode, it may be determined whether the task trigger condition is satisfied by simple and low-cost methods such as the key information search and/or rule matching.

In some embodiments, the terminal device 110 may detect whether the task trigger condition related to the first digital assistant is satisfied by interacting with a target model (e.g., the model 155) based on a second detection mode. In some embodiments, due to the simplicity and low cost of the first detection mode, the terminal device 110 may first detect whether the task trigger condition is satisfied based on the first detection mode. If it cannot be determined whether the task trigger condition is satisfied based on the first detection mode, it may be detected whether the task trigger condition related to the first digital assistant is satisfied by using the model 155 based on the second detection mode. This may help reduce the calculation amount of the terminal device 110 and improve the detection efficiency.

In some embodiments of detecting whether the task trigger condition is satisfied based on the second detection mode, the terminal device 110 may acquire a second prompt based on the first information. The first information here includes information for detecting whether the task trigger condition is satisfied. The second prompt may be used to interact with the model 155, and whether the task trigger condition is satisfied is detected based on an interaction result with the target model. In such embodiments, the information processing capability of the model may be used to help determine whether the task trigger condition is satisfied.

At block 220, the terminal device 110 or the first digital assistant on the terminal device 110 initiates task execution related to the first digital assistant in response to the task trigger condition being satisfied. The task execution includes: obtaining information related to a first task; and performing, by interacting with a target model, at least one of the following based on the obtained information related to the first task: obtaining attribute information of the first task; and executing the first task based on the attribute information of the first task. In some embodiments, the interaction with the target model may occur in attribute information obtaining stage of the first task. In some embodiments, the interaction with the target model may occur in an execution stage of the first task. In some embodiments, both the attribute information obtaining stage and the execution stage of the first task involve the interaction with the target model. The specific use of the target model in each stage will be discussed in the following embodiments.

In this way, information related to task may be obtained under a specific trigger condition and the user may be helped to execute the corresponding task without the need for the user to proactively trigger. The first digital assistant may initiate the execution of the task when the task trigger condition is satisfied, without the need for the user's real-time instructions. In the task execution, the interaction with the target model (e.g., the model 155) may also be used to assist in completing the task.

The information related to the first task refers to information that may be used to determine what task to execute and how to execute the task. In some embodiments, the information related to the first task may be obtained based on the task trigger condition itself. For example, if the task trigger condition is that the first user receives a notification message from a first service component, the information related to the first task may be obtained based on the notification message from the first service component. The information related to the first task may include the notification message itself, information mentioned or cited in the notification message, etc. The information related to the first task may also include information required for executing the first task, which is obtained from a service object related to the first user in the first service component. If the task trigger condition is that an event related to the first user occurs in a second service component, the information related to the first task may also include information required for executing the first task, which is obtained from a service object related to the first user in the second service component. In some embodiments, if the task trigger condition includes the event related to the first user occurring in the second service component, the terminal device 110 may determine the first task based on the event and obtain the information related to the task of the first task.

Alternatively or additionally, the information related to the first task may also be determined from at least one third service component other than the first service component or the second service component related to the task trigger condition, for example, information required for executing the first task may be obtained based on a service object related to the first user in the at least one third service component. The service object related to the first user may include, for example, a document, a meeting, a schedule, a meeting minutes, etc. associated with the first user, which depends on the type of the service component. It should be noted that the service object related to the first user in each service component relied on is a service object that the first user has permission to access. For example, if the service object is a document, the document is a document that the first user has permission to access. This helps to ensure user data security.

In some embodiments, the terminal device 110 may also obtain the task related information of the first task from historical interaction information of the first user. That is, the terminal device 110 may determine the task related information of the first task based on historical interaction information between the first user and the first digital assistant.

In some embodiments, alternatively or additionally, the information related to the first task may be obtained based on input information that causes the task trigger condition to be satisfied. The input information here may include user input, the first information mentioned above, etc.

In some embodiments, alternatively or additionally, the information related to the first task may be obtained based on a knowledge base associated with the task trigger condition. For example, different task trigger conditions may be associated with different services, and these services may have corresponding knowledge bases. Part or all of the information in the knowledge base may be determined as the information related to the first task for determining what task to execute and how to execute the task.

In some embodiments, as mentioned above, the first digital assistant may also be associated with a preset workflow, and whether the execution condition of the one or more work nodes is satisfied is determined based on the preset workflow. In a case where the first digital assistant is associated with the preset workflow, the information related to the first task may also be obtained based on known execution information of the one or more work nodes in the preset workflow. Typically, in the workflow, whether a task at a certain work node or some work nodes is to be executed and/or how to execute the task may need to be determined based on the execution of previous work nodes. In particular, if a certain work node has multiple task branches, it is necessary to determine which task branch to execute subsequently based on the execution of the previous work nodes.

Note that in various embodiments, the obtained task related information is information that the first user corresponding to the first digital assistant has permission to access and that the first user authorizes the terminal device 110 or the first digital assistant to access. Such information acquisition shall comply with the requirements of corresponding laws, regulations and related provisions, and obtain the effective authorization of the corresponding subject of rights.

After the information related to the first task is obtained, the attribute information of the first task is determined based on the obtained information related to the first task. The attribute information of the first task may include the type of the first task, that is, what task is to be executed. The attribute information of the first task may also include parameter information related to the execution of the first task, plugin information or application program development interface (API) information for executing the first task. For example, the type of the first task may indicate creating a schedule, and the parameter information may indicate the time, participants, location, etc. of the schedule to be created. In some embodiments, the plugin information or the API information in the attribute information may indicate a plugin to be called or an interface to be called when the first task is executed. Based on the attribute information of the first task, it may be determined what task to execute and how to execute the task. The attribute information of the first task may also include other types of information as long as these types of information may be used to specify the specific execution manner of the first task to be executed.

In some embodiments, in order to determine the attribute information of the first task, the terminal device 110 or the first digital assistant on the terminal device 110 may acquire a first prompt based on the information related to the first task, and send the first prompt to the model 155. After obtaining the feedback from the model 155, the attribute information of the first task is determined based on the feedback. That is, the model may be used to analyze the prompt obtained based on the information related to the first task, so as to determine the type, parameter information, plugin information, API information, etc. of the task that the first digital assistant needs to proactively execute.

In some embodiments, the terminal device 110 may obtain the task corresponding to the task trigger condition in advance. The terminal device 110 may store the task trigger condition and the corresponding task in association. The terminal device 110 may then obtain the task related information in response to the task trigger condition being satisfied. For example, if the terminal device 110 receives a chat message “Remind me and prepare a reply email whenever I receive a customer complaint email” from the first user in the chat window between the first user and the first digital assistant, the terminal device 110 may determine that the task trigger condition is “receiving a customer complaint email”, and the task corresponding to the task trigger condition is “reminding the first user and preparing a reply email”. The terminal device 110 may then obtain information related to preparing the reply email. That is, in this case, the terminal device 110 may directly determine the task to be executed that matches the task trigger condition based on the task trigger condition. The task to be executed may also be referred to as the first task.

In some embodiments, the terminal device 110 may also only obtain the task trigger condition. The terminal device 110 may determine the task to be executed based on the task trigger condition in response to the task trigger condition being satisfied. In an example, if the task trigger condition includes the first user receiving the notification message from the first service component, the terminal device 110 may determine the first task based on the notification message and obtain the attribute information of the first task (for example, information required for executing the first task). That is, the satisfaction of the specific task trigger condition is used to trigger the terminal device 110 to obtain the attribute information to determine whether the task needs to be executed and what task to execute specifically. For example, if the first service component is a chat service component, the terminal device 110 may determine that the task trigger condition related to the first digital assistant is satisfied in response to receiving, in the first service component, a notification message (e.g., message “Send me a project evaluation”) sent by another user to the first user. The terminal device 110 may determine, based on the notification message, that the first task is to prepare a project evaluation report. The terminal device 110 may then obtain information (e.g., project data for different users) related to preparing the project evaluation report.

Regarding the specific manner of determining the first task based on the notification message, in some embodiments, similar to the determination of the task trigger condition, the terminal device 110 may determine a prompt based on information related to the notification message, send the prompt to the target model, and receive the result returned by the target model. Alternatively or additionally, in some embodiments, the terminal device 110 may also determine the first task matching the notification message based on a predetermined rule.

In some embodiments, the active execution process of the first task may be based on an interactive instruction or a non-interactive instruction with the user. In some embodiments, the first digital assistant may further determine whether the execution process of the first task requires additional input from the first user. If the execution process of the first task does not require the additional input from the first user, the first digital assistant may directly and proactively execute the first task based on the obtained task related information, without the need for an interactive instruction from the user. In some embodiments, if the execution process of the first task requires the additional input from the first user, the first digital assistant may send a message to the first user to instruct the first user to provide additional information about the first task. The first digital assistant may then receive the additional input from the first user and determine the additional information corresponding to the additional input. The first digital assistant may then execute the first task based on the attribute information of the first task and the obtained additional information. In this process, the first digital assistant may complete the first task through an active dialogue with the user 140 and further obtained interaction information. For example, the first digital assistant may first draft a project evaluation report and send it to the user 110 for confirmation and modification by the user, and finally complete the project evaluation report.

It should be noted that both the message instructing the first user to provide the additional information about the first task and the additional message here may be sent and received in the interaction window between the first user and the first digital assistant. For example, the terminal device 110 may send, in the interaction window between the first user and the first digital assistant, the message instructing the first user to provide the additional information about the first task. The terminal device 110 may then obtain the additional information based on multiple rounds of chat between the first user and the first digital assistant. For another example, the terminal device 110 may further present, in the interaction window between the first user and the first digital assistant, an operation control, a quick instruction, etc. associated with the acquisition of the additional input. The terminal device 110 may determine that the additional input is obtained in response to detecting a trigger operation on the corresponding operation control/quick instruction, and then determine the additional information indicated by the additional input.

In some embodiments, the terminal device 110 notifies the first user of the execution result of the first task by the first digital assistant. The terminal device 110 may notify the first user of the execution result of the first task by sending, for example, a notification message indicating the execution result of the first task in the interaction window between the first user and the first digital assistant.

Taking the task trigger condition as an example that the first user receives the notification message from the first service component and the terminal device 110 determines that the execution process of the first task requires the additional input from the first user, if the notification message indicates that the first user needs to complete the project evaluation of an object, the terminal device 110 may determine that the task trigger condition is satisfied in response to receiving the notification message. The terminal device 110 may determine, based on the notification information, that the first task is to prepare a project report of the object. The terminal device 110 may then proactively prepare a project report draft based on work output of the object in the last six months. The project report of the object in the last six months here may be determined by the terminal device 110 based on multiple rounds of conversations between the first digital assistant and the first user. The terminal device 110 may send, in the interaction window between the first user and the first digital assistant, a notification message prompting that the task is completed, and attach the project report.

Taking the task trigger condition as an example that the first user receives the notification message from the first service component and the terminal device 110 determines that the execution process of the first task does not require the additional input from the first user, if the notification message indicates that a new customer intention is found, the first user is requested to follow up. The terminal device 110 may determine that the task trigger condition is satisfied in response to receiving the notification message. The terminal device 110 may determine, based on the notification information, that the first task is to prepare an email to be sent to the new customer. The terminal device 110 may sort out information of the new customer and draft an email draft according to a predetermined process. The information of the new customer here may be obtained by the terminal device 110 from the service object related to the first user in the at least one third service component. The terminal device 110 may send, in the interaction window between the first user and the first digital assistant, the notification message prompting that the task is completed, and attach thereto the information of the new customer and the email draft.

In summary, according to the embodiments of the present disclosure, the terminal device 110 may proactively execute the task indicated by the task trigger condition in response to the task trigger condition related to the digital assistant being satisfied, and may notify the user of the execution result. This may improve the intelligence and autonomy of the digital assistant, improve the flexibility of using the digital assistant, and help to improve the work efficiency of the digital assistant.

An example of the active execution process of a preset workflow (i.e., a first workflow hereinafter) by the digital assistant 120 is described in detail below with reference to FIG. 3. FIG. 3 illustrates a flowchart of a process 300 of task processing according to some embodiments of the present disclosure. For the convenience of discussion, the process 300 will be described with reference to the environment 100 in FIG. 1. The process 300 may be implemented at the terminal device 110 and/or the server 130. For the convenience of description, an example in which the process 300 is implemented at the terminal device 110 is used as an example below. It should be understood that some operations described with reference to the terminal device 110 may require the assistance of the server 130 to complete. It should be noted that the operations performed by the terminal device 110 may specifically be performed by a related application and/or a digital assistant installed on the terminal device 110.

At block 310, the terminal device 110 or the first digital assistant on the terminal device 110 detects whether an execution condition of each work node in a first workflow is satisfied, where the first workflow includes a plurality of work nodes.

The first workflow here may be, for example, any appropriate workflow, which may be pre-entered into the terminal device 110 by the first user. The plurality of work nodes included in the first workflow each have a corresponding task. In some embodiments, there may also be a dependency relationship between tasks corresponding to two or more of the plurality of work nodes. That is, a task of a work node depends on tasks of at least one other work node. In some embodiments, in order to ensure the standardization and accuracy of the first workflow and the plurality of work nodes, the first workflow may be a standard operating procedure (SOP) of a first service. The SOP refers to a standard operating step and requirement for describing an event in a unified format for guiding and standardizing a specific service operation. The SOP usually quantifies details of a specific service. Generally speaking, the SOP refines and quantifies key control points in a certain procedure.

In some embodiments, the terminal device 110 or the first digital assistant on the terminal device 110 may determine whether the execution condition of each of the plurality of work nodes is satisfied based on information related to the first workflow. In some embodiments, the information related to the first workflow may include the first workflow itself, because the first workflow itself defines the work logic, that is, the task dependency relationship between each of the work nodes, the trigger logic of the task branch of each work node, etc. Based at least on the first workflow, the task to be executed at each work node and the execution conditions of these tasks may be determined. In some embodiments, alternatively or additionally, the information related to the first workflow may include service knowledge information corresponding to the first workflow. In some embodiments, alternatively or additionally, the information related to the first workflow may include known execution information of one or more of the plurality of work nodes. Usually, in the workflow, whether a task at a certain work node or some work nodes is to be executed and/or how to execute the task may need to be determined based on the execution of previous work nodes. In particular, if a certain work node has multiple task branches, it is necessary to determine which task branch to execute subsequently based on the execution of the previous work nodes. In some embodiments, alternatively or additionally, the information related to the first workflow may include user feedback related to one or more of the plurality of work nodes. Different work nodes may be detected and fed back by corresponding users. If the feedback for a certain work node is received, it may be necessary to determine whether the task corresponding to the work node is to be triggered for execution.

In some embodiments, the terminal device 110 may obtain the execution condition of each work node of the first workflow. For example, if the first workflow is the standard operating procedure, the terminal device 110 may directly determine the execution condition of each work node based on the standard operating procedure. The terminal device 110 may then detect whether the execution condition of each work node in the first workflow is satisfied based on the execution condition of each work node.

In an example, taking the first workflow as an example of the standard operating procedure for the room inspection service of a hotel, the terminal device 110 may determine, based on the first workflow, a plurality of work nodes required for the room inspection and tasks corresponding to the plurality of work nodes, respectively. The terminal device 110 may then sequentially detect whether the execution condition of each work node is satisfied. For example, if the execution condition of a work node of repairing a room shower system is that the room shower system is damaged, the terminal device 110 may determine whether the execution condition of the work node of repairing the room shower system is satisfied based on a determination result of whether the room shower system is damaged.

In some embodiments, the terminal device 110 may continuously detect whether one or more execution conditions for each node are satisfied. In some embodiments, the terminal device 110 may detect whether the execution condition is satisfied by using a target model (e.g., the model 155). In some embodiments, considering the resource and time overhead of model calling, the terminal device 110 may use different detection modes to detect whether the execution condition is satisfied.

In some embodiments, the terminal device 110 may detect whether the execution condition of each work node is satisfied based on a first detection mode, where the first detection mode includes detection modes other than the interaction with the target model. In some examples, the first detection mode may include performing a key information search for first information, the first information including information for detecting whether the execution condition of each work node is satisfied. For example, at least one keyword associated with the execution condition may be acquired. The at least one keyword may be determined by the first user, or may be determined by the terminal device 110 on its own based on the execution condition. The terminal device 110 may then search, based on a keyword detection manner, whether the first information includes one or more keywords associated with the execution condition, thereby detecting whether the execution condition related to each work node is satisfied. In some embodiments, alternatively or additionally, the first detection mode further includes detecting whether the first information satisfies a preset rule. If the first information satisfies the preset rule, it may be determined that the execution condition related to each work node is satisfied. That is, in the first detection mode, it may be determined whether the execution condition is satisfied by simple and low-cost methods such as the key information search and/or rule matching.

In some embodiments, the terminal device 110 may detect whether the execution condition related to each work node is satisfied by interacting with a target model (e.g., the model 155) based on a second detection mode. In some embodiments, due to the simplicity and low cost of the first detection mode, the terminal device 110 may first detect whether the execution condition is satisfied based on the first detection mode. If it cannot be determined whether the execution condition is satisfied based on the first detection mode, it may be detected whether the execution condition related to each work node is satisfied by using the model 155 based on the second detection mode. This may help reduce the calculation amount of the terminal device 110 and improve the detection efficiency.

In some embodiments of detecting whether the execution condition is satisfied based on the second detection mode, the terminal device 110 may acquire a second prompt based on the first information. The first information here includes information for detecting whether the execution condition is satisfied. The second prompt may be used to interact with the model 155, and whether the execution condition is satisfied is detected based on an interaction result with the target model. In such embodiments, the information processing capability of the model may be used to help determine whether the execution condition is satisfied.

When detecting whether the execution condition of each work node is satisfied based on the first detection mode or the second detection mode, it may be determined whether the execution condition is satisfied based on one or more of the first workflow itself, the service knowledge information, the known execution information, and the user feedback.

At block 320, the terminal device 110 or the first digital assistant on the terminal device 110 obtain information related to a first work node in response to detecting that an execution condition of the first work node in the first workflow is satisfied.

In some embodiments, the information related to the first work node may include service knowledge information corresponding to the first workflow and/or known execution information corresponding to the first work node. In some embodiments, the terminal device 110 may also obtain the service knowledge information corresponding to the first workflow in advance. Such service knowledge information may be, for example, knowledge information matching the service type of the first workflow. For example, if the first workflow is the service flow of the hotel room inspection service, the corresponding service knowledge information may include knowledge information such as hotel management, room cleaning, equipment repair, and room management. The known execution information corresponding to the first work node may include, for example, a task execution result corresponding to at least one second work node on which the first work node depends. In an example, if the first work node and the second work node are adjacent nodes, and the first work node is located behind the second work node (i.e., the first work node depends on the second work node), the first work node may execute the task corresponding to the first work node only if the second work node completes the task corresponding to the second work node. In this case, the terminal device 110 may obtain the execution result of the second work node and determine it as the known execution information corresponding to the first work node.

In some embodiments, the detection of the execution condition, the obtaining of the related information, and the subsequent determination of the task and execution of the task may all be performed by the first digital assistant in the terminal device 110. In this case, the terminal device 110 may receive a configuration operation from the first user on the first digital assistant. The configuration operation may include, for example, associating the first workflow with the first digital assistant. It is to be understood that the first digital assistant can only detect whether the execution condition of each work node in the first workflow is satisfied only when the first workflow is associated with the first digital assistant. The configuration operation may also include, for example, associating the service knowledge information corresponding to the first workflow with the first digital assistant. Similarly, it may be understood that only when the service knowledge information corresponding to the first workflow is associated with the first digital assistant, the first digital assistant may directly obtain the service knowledge information, and perform operations such as task determination based on the service knowledge information.

In the case that the detection of the execution condition, the obtaining of the related information, and the subsequent determination of the task and execution of the task are all performed by the first digital assistant in the terminal device 110, the first digital assistant may also send information about the execution of the first workflow to the first user (i.e., the user corresponding to the terminal device 110, for example, the user using the terminal device 110). Therefore, the first user may know the execution of the first workflow at any time, and the interaction experience between the first user and the digital assistant may be improved. In this case, the first digital assistant may also send a message to the first user to instruct the first user to provide additional information about the first work node. By way of example, the first digital assistant may send, in the interaction window between the first user and the first digital assistant, the message instructing the first user to provide the additional information about the first work node. The terminal device 110 may then obtain the additional information based on multiple rounds of chats between the first user and the first digital assistant. For another example, the terminal device 110 may further present, in the interaction window between the first user and the first digital assistant, an operation control, a quick instruction, etc. associated with the acquisition of the additional input. The terminal device 110 may determine that the additional input is obtained in response to detecting a trigger operation on the corresponding operation control/quick instruction, and then determine the additional information indicated by the additional input. The first digital assistant may use the additional information provided by the first user as a part of the information related to the first work node.

Note that the obtained related information is information that the first user corresponding to the first digital assistant has permission to access and that the first user authorizes the terminal device 110 or the first digital assistant to access. Such information acquisition shall meet the requirements of corresponding laws, regulations and related provisions.

At block 330, the terminal device 110 or the first digital assistant on the terminal device 110 determines at least one task to be executed based on the information related to the first work node.

In some embodiments, the terminal device 110 may determine the at least one task to be executed corresponding to the first work node based on a predetermined rule and the information related to the first work node. As described above, the determination of the task may also be performed by the first digital assistant, which will not be repeated here. In some embodiments, the terminal device 110 may also use the target model to determine the at least one task to be executed. Specifically, the terminal device 110 may determine a prompt based on the information related to the first work node, and send the prompt to the target model. The terminal device 110 may receive the result returned by the target model that contains the information of the at least one task to be executed. The terminal device 110 may determine the information of the at least one task to be executed based on the result received from the target model, and then determine the at least one task to be executed at the first work node. In some embodiments, the target model may be a machine learning model, a deep learning model, a learning model, a neural network, etc. In some embodiments, the target model may be based on a language model (LM). The language model may have a question answering capability by learning from a large amount of corpus. The target model may also be based on other appropriate models.

In some embodiments, the terminal device 110 may further determine, based on the information related to the first work node, the at least one task to be executed and whether to currently execute the at least one task. For example, if the known execution information corresponding to the first work node indicates that the task execution result corresponding to the at least one second work node on which the first work node depends indicates that there is a second work node that has not completed the task and/or there is a second work node that has failed to execute the task, the terminal device 110 may determine to first complete the tasks corresponding to all the second work nodes, and then execute the at least one task corresponding to the first work node. The terminal device 110 may determine to execute the at least one task corresponding to the first work node in response to the known execution information corresponding to the first work node indicating that the task execution result corresponding to the at least one second work node indicates that all the tasks corresponding to the at least one second work node have been executed.

At block 340, the terminal device 110 or the first digital assistant on the terminal device 110 executes at least a portion of the at least one task, and/or assigns at least a portion of the at least one task to a target execution body.

In some embodiments, the first digital assistant may be used to execute at least a portion of the at least one task. In some embodiments, at least a portion of the at least one task may be assigned to the target execution body by the first digital assistant. In some embodiments, at least one step of the process 300 is performed by the first digital assistant. The at least one step of the method performed by the first digital assistant includes: determining a prompt based on the information related to the first workflow; interacting with the target model through the first digital assistant based on the prompt; and performing the at least one step based on the interaction result.

In some embodiments, the terminal device 110 may determine the target execution body of each of the at least one task corresponding to the first work node. If the terminal device 110 determines that the execution body of the at least one task is the terminal device 110 itself, the terminal device 110 may directly execute the at least one task. If the terminal device 110 determines that there is at least a portion of the task that needs to be executed by the user/the terminal device 110/the digital assistant in the at least one task, the terminal device 110 may assign the at least a portion of the task to their respective target execution bodies. The target execution body may be another user, another digital assistant, or another application.

Specifically, if the terminal device 110 determines that there is at least a portion of the task that needs to be executed by the user, the terminal device 110 may determine the user (which may include the first user and other users other than the first user) associated with the at least a portion of the task, and send a notification message to the user associated with the at least a portion of the task. The notification may indicate the at least a portion of the task that needs to be executed by the user. If the terminal device 110 determines that there is at least a portion of the task that needs to be executed by another terminal device 110, the terminal device 110 may also determine the another terminal device 110 (which may also be referred to as a second terminal device 110) associated with the at least a portion of the task, and send a notification message to the second terminal device 110 indicating the at least a portion of the task that needs to be executed by the second terminal device 110. If the terminal device 110 determines that there is at least a portion of the task that needs to be executed by another digital assistant, the terminal device 110 may also determine another digital assistant (which may also be referred to as a second digital assistant) associated with the at least a portion of the task.

It should be noted that the second digital assistant may be a digital assistant installed on the same terminal device 110 as the first digital assistant. For example, a first service component and a second service component may be installed on the terminal device 110, the first digital assistant may be integrated on the first service component, and the second digital assistant may be integrated on the second service component. The second digital assistant may also be a digital assistant installed in a different terminal device 110 from the first digital assistant. For example, a first terminal device 110 is installed with the first digital assistant, and a second terminal device 110 is installed with the second digital assistant. The terminal device 110 may send a notification message to the determined second digital assistant indicating at least a portion of the task that needs to be executed by the second digital assistant.

For example, taking the first workflow as an example of the standard operating procedure for the room inspection service of a hotel. If the terminal device 110 determines that the execution condition of the work node of repairing the room shower system is satisfied, the terminal device 110 may determine that the room shower repair task corresponding to this work node needs to be executed. The terminal device 110 may send a notification message to a corresponding repair team indicating the execution of the room shower repair task in response to determining that the task needs to be executed by the repair team.

In some embodiments, the terminal device 110 may also track and record the execution result of the at least one task corresponding to the first work node. The terminal device 110 may also send the execution result of the at least one task to the first user, for example, so that the first user may know the execution of the first workflow in real time.

In some embodiments, if it is determined that the execution condition of another work node in the workflow is satisfied, the terminal device 110 or the first digital assistant on the terminal device 110 may also execute the task corresponding to the another work node according to a similar process, so that the tasks corresponding to each work node on the workflow are all checked and/or executed.

In summary, according to embodiments of the present disclosure, the terminal device 110 may determine at least one task corresponding to the first work node in response to the execution condition of the first work node in the workflow being satisfied. The terminal device 110 may also proactively execute the at least one task or assign the at least one task to a corresponding execution body. This may improve the intelligence, autonomy and flexibility of the digital assistant, and improve the work efficiency in each service scenario.

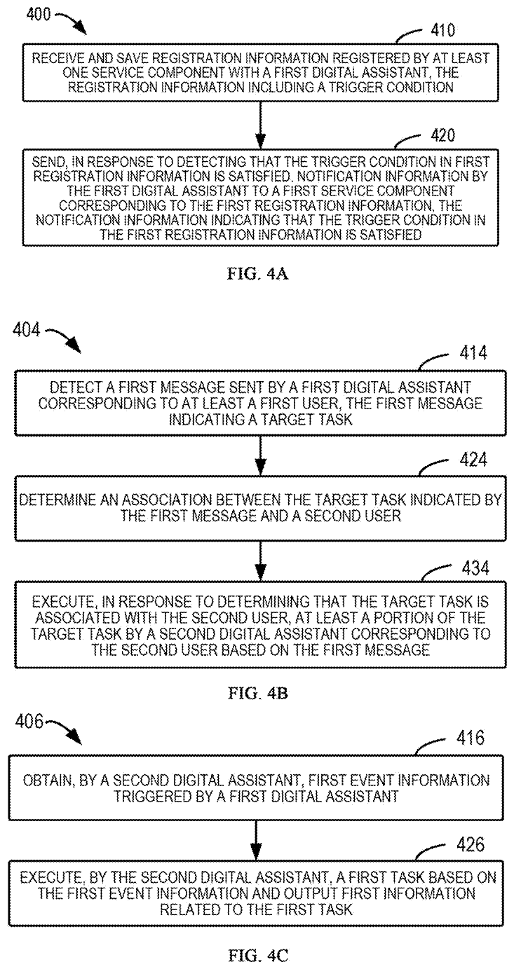

Multiple examples of the first digital assistant executing the corresponding task in response to the satisfaction of the task trigger condition associated with the first digital assistant are described above. Some example embodiments in which the first digital assistant obtains the trigger condition of the service component other than the service component integrating the first digital assistant and notifies another service component in response to the satisfaction of the trigger condition, so that the other service component executes the corresponding task, will be described below. An example of the interaction between the first digital assistant and another service component is described in detail below with reference to FIG. 4A. It should be noted that the first digital assistant being integrated in the first service component is taken as an example for description above, and the first digital assistant not being integrated in the first service component is taken as an example for description below.

FIG. 4A illustrates a flowchart of a process 400 of task processing according to some embodiments of the present disclosure. For the convenience of discussion, the process 400 will be described with reference to the environment 100 in FIG. 1. The process 400 may be implemented at the terminal device 110 and/or the server 130. For the convenience of description, an example in which the process 400 is implemented at the terminal device 110 is used as an example below. It should be understood that some operations described with reference to the terminal device 110 may require the assistance of the server 130 to complete. It should be noted that the operations performed by the terminal device 110 may specifically be performed by a related application and/or a digital assistant installed on the terminal device 110.

At block 410, the terminal device 110 or the first digital assistant on the terminal device 110 stores corresponding registration information registered by at least one service component with the first digital assistant, the corresponding registration information of the at least one service component respectively including a trigger condition. Such a service component may include another digital assistant service component, or may be a service component without any digital assistant. The first digital assistant may manage the registration information of different service components, and associate the service component with the registered trigger condition.

It may be understood that the first digital assistant corresponds to the first user, and the first user may include one or more users, that is, the first digital assistant may be a personal assistant, a team assistant/organizational assistant, and so on. In some embodiments, the first digital assistant may provide any suitable interface, such as an open interface (API). The first digital assistant may receive, based on the open interface, the registration information related to the trigger condition sent by the at least one service component. It may be understood that the first digital assistant may manage the registration information it receives.

The first trigger condition of the first service component is described below by taking the first service component in the at least one service component as an example. The first service component here may be any service component in the at least one service component. The first trigger condition may include, for example, that the first user receives a notification message from the first service component. In this case, the terminal device 110 may determine that the first trigger condition of the first service component is satisfied in response to detecting the notification information from the first service component. The notification message here may be a notification message of the service component itself, or may be a notification message sent by a contact in the service component. In some embodiments, the user may also limit a type of the notification message. In this case, the terminal device 110 may determine that the first trigger condition is satisfied in response to detecting notification information of a predetermined type from the first service component.

The first trigger condition may also include, for example, that an event related to the first user occurs in the first service component or the second service component. The second service component here may be a different service component from the first service component. The event related to the first user here may also be any appropriate event, such as a calendar event associated with the first user, a time change event, a message notification event, a document change event, an email sending and receiving event, a task update event, etc.

The first trigger condition may also include, for example, that a preset time is reached. In this case, the terminal device 110 may determine that the first trigger condition is satisfied in response to the current time reaching the preset time. The first trigger condition may also include, for example, that an execution condition of one or more work nodes in a preset workflow is satisfied. The preset workflow here may include a plurality of work nodes. The plurality of work nodes respectively have corresponding tasks, and there is a dependency relationship between tasks corresponding to two or more of the plurality of work nodes. For example, if a first node and a second node are adjacent nodes, and the first node is located before the second node, the second node may execute a task corresponding to the second node only if the first node completes a task corresponding to the first node. In this case, the terminal device 110 may determine that the first trigger condition is satisfied, for example, in response to detecting that an execution condition of a work node is satisfied.

The first trigger condition may also include a combination of one or more of the first user receiving the notification message from the first service component, the event related to the first user occurring in the first service component or the second service component, the preset time being reached, the execution condition of the one or more work nodes in the preset workflow being satisfied, etc. For example, the task trigger condition may include that the preset time is reached, and the first user receives the notification message from the first service component. It may be understood that the first trigger condition may also include any appropriate condition, which is not limited in the present disclosure.

In some embodiments, the registration information received by the first digital assistant here may be determined based on the input of the first user. As described above, the first user may include one or more users, therefore, in some embodiments, the registration information may be based on the input of any of the one or more users, and the trigger condition included in the corresponding registration information of the at least one service component may also be associated with the one or more users. Specifically, the terminal device 110 may receive at least one user input of the first user on the first digital assistant. The terminal device 110 may receive at least one chat message from the first user (e.g., any service component in the at least one service component) in the interaction window between the first user and the first digital assistant, and determine the at least one user input based on the at least one chat message. The terminal device 110 may determine a second trigger condition of a task executed for the second service component from the at least one user input. The terminal device 110 may then store second registration information of the second service component in response to the determination of the second trigger condition, the second registration information including the second trigger condition. It should be noted that the operations performed by the terminal device 110 here and below may also be performed by the first digital assistant. For example, the first user may instruct the first digital assistant to send a notification to the second service component under what condition in the form of a natural language.

In some embodiments, the corresponding registration information of the at least one service component may also be sent by the at least one service component. Exemplarily, if the at least one service component may determine the trigger condition on its own, the terminal device 110 may directly receive the registration information including the trigger condition sent by the service component. Specifically, the terminal device 110 may also directly receive third registration information including a third trigger condition from a third service component (e.g., any service component in the at least one service component). The terminal device 110 may then store the received third registration information. Regarding the specific manner in which the third service component determines the third trigger condition, in some embodiments, the third service component may determine the third trigger condition based on the execution condition of the task for which the third trigger condition is used and/or the interaction between the first user and the third service component.

In some embodiments, the interaction information between the first user and a certain service component sent by the service component may be received, and the terminal device 110 may then determine the trigger condition based on the received interaction information. For example, if a service component cannot determine the trigger condition on its own, the service component may send the interaction information to the first digital assistant. Specifically, the terminal device 110 may receive interaction information between the first user and a fourth service component from the fourth service component in the at least one service component (e.g., any service component in the at least one service component). Note that the interaction information is the first user authorizing the service component to send to the first digital assistant. Such information acquisition shall meet the requirements of corresponding laws, regulations and related provisions.

The terminal device 110 may determine a fourth trigger condition of a task to be executed for the fourth service component from the interaction information. The terminal device 110 or the first digital assistant on the terminal device 110 may store fourth registration information of the fourth service component in response to the determination of the fourth trigger condition, the fourth registration information including the fourth trigger condition. The terminal device 110 may, for example, provide the received interaction information between the first user and the fourth service component to a model and obtain the fourth trigger condition determined by the model. In some embodiments, the model may be a machine learning model, a deep learning model, a learning model, a neural network, etc. In some embodiments, the model may be based on a language model (LM). The language model may have a question answering capability by learning from a large amount of corpus. The model may also be based on other appropriate models.

In some embodiments, the terminal device 110 may also determine whether the at least one service component has the permission to access the object. If yes, the terminal device 110 may store the registration information of the corresponding service component. If not, the terminal device 110 may prohibit the registration of the corresponding service component. Specifically, for a fifth trigger condition corresponding to a fifth service component (any service component in the at least one service component), the terminal device 110 may determine the object to be accessed to detect whether the fifth trigger condition is satisfied. The terminal device 110 may then determine whether the fifth service component has the permission to access the object. The terminal device 110 may prohibit the fifth service component from registering the fifth trigger condition with the first digital assistant in response to the fifth service component not having the permission to access, that is, the first digital assistant may not store the registration information of the fifth service component and may not detect whether the fifth trigger condition is satisfied. Exemplarily, if the fifth service component is a document service component, and the fifth trigger condition of the fifth service component is “receiving an email sent to the first user”, the terminal device 110 may determine, based on the fifth trigger condition, that the object to be accessed is the email. The terminal device 110 may then determine whether the fifth service component has the permission to access the email. If yes, the terminal device 110 may store fifth registration information of the fifth service component. If not, the terminal device 110 may prohibit the fifth service component from registering the fifth trigger condition. The terminal device 110 may send, for example, a prompt message to the fifth service component to prompt that it does not have the permission to access. Therefore, the security of user data may be ensured.

At block 420, the terminal device 110 or the first digital assistant on the terminal device 110, in response to detecting that the first trigger condition in the first registration information is satisfied, sends notification information to the first service component corresponding to the first registration information, the notification information indicating that the first trigger condition is satisfied.

In some embodiments, the first digital assistant may send the notification message to the first service component through the open interface through which it receives the registration information. In some embodiments, in order to help the first service component to better execute the task corresponding to the first trigger condition, the first digital assistant may send contextual information related to the first trigger condition to the first service component in response to detecting that the first trigger condition is satisfied. The contextual information here may be used for the first service component to execute the corresponding task. For example, if the first trigger condition is receiving an email sent to the first user, and the email indicates that a document is to be created, the first digital assistant may send the requirement for creating the document included in the email to the first service component, so that the first service component creates the document based on the requirement.

In summary, according to embodiments of the present disclosure, the terminal device 110 may store the registration information, which includes the corresponding trigger condition, registered by the service component with the digital assistant. The digital assistant may notify the corresponding service component to execute the task corresponding to the trigger condition in response to detecting that the trigger condition is satisfied. This may improve the intelligence and autonomy of the digital assistant, improve the flexibility of the digital assistant, and improve the work efficiency of the digital assistant.

FIG. 4B illustrates a flowchart of a process 404 of task processing according to some embodiments of the present disclosure. For the convenience of discussion, the process 404 will be described with reference to the environment 100 in FIG. 1. The process 404 may be implemented at the terminal device 110 and/or the server 130. For the convenience of description, an example in which the process 404 is implemented at the terminal device 110 is used as an example below. It should be understood that some operations described with reference to the terminal device 110 may require the assistance of the server 130 to complete. It should be noted that the operations performed by the terminal device 110 may specifically be performed by a related service component and/or a digital assistant installed on the terminal device 110.

At block 414, the terminal device 110 or a second digital assistant on the terminal device 110 detects a first message sent by the first digital assistant corresponding to at least a first user, the first message indicating a target task.

The first digital assistant here may be a digital assistant corresponding to only one first user, or may be a digital assistant corresponding to multiple users including the first user. That is, the first digital assistant may be a personal assistant, a team assistant/an organizational assistant, etc. The second digital assistant may be, for example, a digital assistant corresponding only to the second user (that is, a personal digital assistant of the second user). The second digital assistant and the first digital assistant may both be installed in the terminal device 110.

Regarding the determination of the target task and the sending of the first message, the target task here may be, for example, a task determined by the terminal device 110 or the first digital assistant on its own based on at least one chat message in a group chat. The terminal device 110 or the first digital assistant may analyze the content of the at least one chat message in the group chat to determine the target task corresponding to the at least one chat message, for example. Exemplarily, the terminal device 110 or the first digital assistant may determine that the target task corresponding to the at least one chat message is the task “booking a meeting room” in response to the existence of the text “booking a meeting room” in the content of the at least one chat message. It may be understood that the at least one chat message in the group chat here is only an example, and the target task may also be a task determined by the terminal device 110 or the first digital assistant based on other information such as the content of a document, the content of an email, the content of a meeting, etc. For example, the terminal device 110 or the first digital assistant may also summarize based on the content of a certain document, and determine the target task based on the summary result.

The terminal device 110 or the first digital assistant may determine the target task based on the at least one chat message and a predetermined matching rule, for example. The terminal device 110 or the first digital assistant may also determine the target task indicated by the at least one chat message by using a model, for example. In some embodiments, the terminal device 110 or the first digital assistant may construct a prompt input based on the at least one chat message. The terminal device 110 or the first digital assistant may provide the prompt input to the model and obtain the target task determined by the model. In some embodiments, the model may be a machine learning model, a deep learning model, a learning model, a neural network, etc. In some embodiments, the model may be based on a language model (LM). The language model may obtain a question answering capability by learning from a large corpus. The model may also be based on other appropriate models.

The target task here may also be a task determined by the terminal device 110 or the first digital assistant on its own based on a workflow associated with the group chat. In some embodiments, the terminal device 110 or the first digital assistant may obtain at least one workflow in advance. The at least one workflow may include a workflow preset by at least one user (the at least one user includes the first user) corresponding to the first digital assistant. The at least one workflow may also include a workflow determined by the terminal device 110 or the first digital assistant on its own based on the historical tasks of the at least one user corresponding to the first digital assistant. The terminal device 110 or the first digital assistant may determine, for example, the workflow associated with the group chat and the target work node in the workflow based on at least one chat message in the group chat, the target work node being the work node currently being executed or to be executed in the workflow. The terminal device 110 and/or the first digital assistant may then determine the target task based on the target work node. Similarly, the workflow associated with the group chat and the target work node here may be determined by the terminal device 110 or the first digital assistant based on a predetermined rule, or may be determined by using the model.

The target task here may also be a task set by at least one user (that is, at least one user with the permission to set the first digital assistant) corresponding to the first digital assistant. Exemplarily, in the group chat, a user (e.g., the first user) participating in the group chat and corresponding to the first digital assistant may set the first digital assistant. The first user may send a chat message indicating the target task to the first digital assistant, for example, and the first digital assistant may determine that the target task is received in response to receiving the chat message.

In some embodiments, after determining the target task, the terminal device 110 or the first digital assistant may also set the content or attribute of the first message to indicate that the target task is associated with the second user in response to an association relationship between the first digital assistant and the second digital assistant for the target task. The association relationship here may be that the first digital assistant and the second digital assistant belong to a workflow including the target task. Exemplarily, if the first digital assistant and the second digital assistant belong to the workflow including the target task, the terminal device 110 or the first digital assistant may set the content or attribute of the first message to indicate that the target task is associated with the second user. For example, the terminal device 110 or the first digital assistant may set the first message to be an announcement message of a group chat including the second user or the second digital assistant to indicate that the target task is associated with the second user.

The association relationship here may also be that the second digital assistant sends a trigger request for one or more tasks to the first digital assistant, where the one or more tasks include the target task. Exemplarily, the terminal device 110 or the first digital assistant may determine that the trigger request for the one or more tasks sent by the second digital assistant to the first digital assistant is received in response to detecting that the second digital assistant pays attention to the first digital assistant, the second digital assistant subscribes to the first digital assistant, etc. The terminal device 110 or the first digital assistant may set the content or attribute of the first message to indicate that the target task in the one or more tasks is associated with the second user in response to the second digital assistant sending the trigger request for the one or more tasks to the first digital assistant.

The terminal device 110 may use the first digital assistant to send the first message indicating the target task in the group chat in response to determining the target task and the association between the target task and the second user. The first digital assistant may send the first message by sending a chat message in the group chat, for example. The first digital assistant may also send the first message by sending an announcement/notification in the group chat, setting a pop-up window, etc. The present disclosure does not limit the specific manner in which the first digital assistant sends the first message.

The first message sent by the first digital assistant may be, for example, an instant messaging (IM) message. The first message may also be the summary/analysis content included in a document, an email, or any other appropriate information carrier. The first message may be any appropriate type of message, for example, it may include text, image, audio, video, link, etc., which is not limited by the present disclosure. Exemplarily, in the group chat, the terminal device 110 or the second digital assistant on the terminal device 110 may receive a chat message from the first digital assistant. Such a group chat includes at least the first digital assistant, the first user, and the second user. It may be understood that the first digital assistant may be a digital assistant corresponding to the first user, or a digital assistant corresponding to all users (including the first user and the second user) participating in the group chat. The second digital assistant may or may not be in the group chat. If the second digital assistant is in the group chat, it may directly receive the first message sent by the first digital assistant in the group chat. If the second digital assistant is not in the group chat, it may also detect all messages in the service component (e.g., the chat service component), where these messages include messages in each chat in the service component.

It should be noted that both the first digital assistant and the second digital assistant here should be digital assistants that have acquired user authorization. For example, for the second user, only the second digital assistant that has acquired the authorization of the second user may detect the first message.

At block 424, the terminal device 110 or the second digital assistant on the terminal device 110 determines the association between the target task indicated by the first message and the second user.

In some embodiments, the terminal device 110 or the second digital assistant may determine the content of the first message and/or the attribute of the first message based on the first message. The terminal device 110 or the second digital assistant may then determine the association between the target task and the second user based on the content and/or attribute of the first message.

Specifically, the terminal device 110 or the second digital assistant may also determine that the target task is associated with the second user in response to the first message including the name of the second user or the second digital assistant. Exemplarily, the terminal device 110 or the second digital assistant may determine that the target task indicated by the first message is associated with the second user in response to the first message including the text “second user”, the text “second digital assistant”, etc. In some embodiments, in order to ensure the accuracy of the association determination, the terminal device 110 or the second digital assistant may also determine that the target task is associated with the second user in response to the first message including a mention symbol for the second user or the second digital assistant. The mention symbol for the second user or the second digital assistant here may include the mention symbol and the name of the second user or the second digital assistant. Exemplarily, the terminal device 110 or the second digital assistant may determine that the target task indicated by the first message is associated with the second user in response to the first message including “@second user”, “@second digital assistant”, etc.

The terminal device 110 or the second digital assistant may also determine that the target task is associated with the second user in response to the first message being an announcement message of a group chat including the second user or the second digital assistant. In this case, since the announcement message is an announcement message for all users and all digital assistants in the group chat, the terminal device 110 or the second digital assistant may determine that the target task indicated by the announcement message (i.e., the first message) is associated with the second user in response to the second user and/or the second digital assistant being in the group chat.

The terminal device 110 or the second digital assistant may also determine that the target task is associated with the second user in response to the first message being sent to a group including the second user. It may be understood that the second user may be a user in a certain user group. The terminal device 110 or the second digital assistant may determine that the target task indicated by the first message is associated with the second user in response to the first message being a message for the group in which the second user is located. Exemplarily, the terminal device or the second digital assistant may determine that the target task is associated with the second user in response to the first message including a mention symbol for the group in which the second user is located. For example, if the group in which the second user is located is a “project group”, the terminal device 110 or the second digital assistant may determine that the target task indicated by the first message is associated with the second user in response to the first message being a message sent to all users in the project group, or in response to the first message including a mention symbol for the “project group”.

In some embodiments, the terminal device 110 or the second digital assistant may also determine that the target task is associated with the second user in response to determining that there is an association relationship between the first digital assistant and the second digital assistant for the target task. That is, the terminal device 110 may also determine that the target task is associated with the second user in response to determining that the first digital assistant and the second digital assistant belong to a workflow including the target task, and/or the second digital assistant sends a trigger request for one or more tasks including the target task to the first digital assistant.

At block 230, the terminal device 110 executes, in response to determining that the target task is associated with the second user, at least a portion of the target task based on the first message by the second digital assistant corresponding to the second user.

It should be noted that the enabling of the task execution function of the digital assistant, the obtained data, the data processing and storage manner, etc. in the embodiments of the present disclosure shall all be authorized in advance by the user and other subjects of rights associated with the user, and shall comply with the provisions of relevant laws and regulations and agreement rules between the subjects of rights. Moreover, the digital assistant proactively executes the relevant task within the authorization scope of the user.

After determining that the target task is associated with the second user, the terminal device 110 may instruct the second digital assistant to execute at least a portion of the target task based on the content of the first message. It may be understood that if the second digital assistant determines that the target task is associated with the second user, it may execute at least a portion of the target task on its own based on the content of the first message. Specifically, the terminal device 110 or the second digital assistant may determine, based on the first message, whether the second user needs to execute the entire target task or a portion of the target task. For example, if the target task indicates booking a meeting room, the terminal device 110 or the second digital assistant may execute the target task based on the first message. If the target task indicates holding a meeting, since the task of holding a meeting may also include multiple subtasks (e.g., booking a meeting room, determining the meeting content, determining the participants, etc.), the terminal device 110 or the second digital assistant may also determine, at least based on the first message, which specific subtask in holding the meeting the second user executes, and only execute the subtask.

In some embodiments, before executing at least a portion of the target task, the terminal device 110 or the second digital assistant may also provide a confirmation message associated with the target task to the second user. The terminal device 110 or the second digital assistant may further determine that at least a portion of the target task may be executed in response to receiving a confirmation operation from the second user on the confirmation message.

An example in which the first digital assistant and the second digital assistant have an association relationship is described in detail below with reference to FIG. 4C. FIG. 4C illustrates a flowchart of a process 406 of task processing according to some embodiments of the present disclosure. For the convenience of discussion, the process 406 will be described with reference to the environment 100 in FIG. 1. The process 406 may be implemented at the terminal device 110 and/or the server 130. For the convenience of description, an example in which the process 406 is implemented at the terminal device 110 is used as an example below. It should be understood that some operations described with reference to the terminal device 110 may require the assistance of the server 130 to complete. It should be noted that the operations performed by the terminal device 110 may specifically be performed by a related service component and/or a digital assistant installed on the terminal device 110.

At block 416, the terminal device 110 or the second digital assistant on the terminal device 110 obtains first event information triggered by the first digital assistant. The first digital assistant and the second digital assistant here have a certain association relationship, and the association relationship may be, for example, that the second digital assistant and the first digital assistant are in the same service entity. The service entity here may include, for example, but is not limited to, a group, a document, a meeting, a project, a task, etc. The association relationship may also be, for example, that the second digital assistant pays attention to the first digital assistant and/or the second digital assistant subscribes to at least part of the functions of the first digital assistant.

The first digital assistant may be a digital assistant associated with the first user. The first digital assistant may also be a digital assistant of the first service component. The first service component may be, for example, a meeting, a document, a calendar, etc. Accordingly, the digital assistant of the first service component may include, for example, a meeting assistant, a document assistant, a calendar assistant, etc. It may be understood that the digital assistant of the first service component is associated with all users corresponding to the first service component. For example, the meeting assistant is associated with all users participating in the meeting. The second digital assistant is a digital assistant associated with the second user, and the second digital assistant may output first information related to the first task to the second user.

The second digital assistant obtains the first event information triggered by the first digital assistant associated with the second digital assistant, and determines the first task indicated by the first time information. In an example, if the first event information triggered by the first digital assistant indicates booking a meeting room, the second digital assistant may determine that the first task indicated by the first event information is booking a meeting room after obtaining the first event information.

At block 426, the terminal device 110 or the second digital assistant on the terminal device 110 executes the first task and outputs the first information related to the first task based on the first event information.

The first information related to the first task output by the terminal device 110 or the second digital assistant may be, for example, the execution result of the first task, the execution state of the first task, the execution progress of the first task, etc. The terminal device 110 or the second digital assistant may output the first information related to the first task by sending a chat message to the second user, for example. The chat message may include text, pictures, audio, etc. The second user may determine the first information related to the first task based on the chat message.

In summary, according to embodiments of the present disclosure, the digital assistant may obtain the information indicating the task sent by another digital assistant, and execute the task based on the information. This may improve the intelligence and autonomy of the digital assistant, improve the flexibility of the digital assistant, and help improve the work efficiency of the digital assistant.

It should be understood that some embodiments in the process 200, the process 300, the process 400, the process 402, the process 404, and the process 406 described above may be implemented together or separately on the terminal device 110 of a certain user.

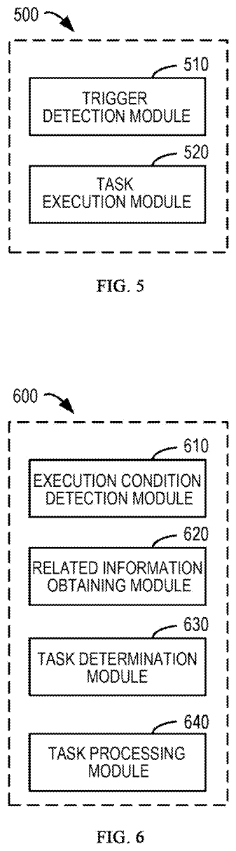

FIG. 5 illustrates a block diagram of an apparatus 500 for task processing according to some embodiments of the present disclosure. The apparatus 500 may be implemented or included in the terminal device 110, for example. Each module/component in the apparatus 500 may be implemented by hardware, software, firmware, or any combination thereof.

As shown in the figure, the apparatus 500 includes a trigger detection module 510 configured to detect whether a task trigger condition related to a first digital assistant is satisfied. The apparatus 500 also includes a task execution module 520 configured to initiate task execution related to the first digital assistant in response to the task trigger condition being satisfied. The task execution includes: obtaining information related to the first task; and based on the obtained information related to the first task, performing, by interacting with a target model, at least one of the following: obtaining attribute information of a first task; or executing the first task based on the attribute information of the first task.

In some embodiments, the task execution module 520 includes: a first prompt sending module configured to send a first prompt obtained based on the information related to the first task to the target model; and obtaining feedback from the target model; and an attribute determination module configured to determine the attribute information of the first task based on the feedback.

In some embodiments, the task execution module 520 is configured to obtain the information related to the first task based on at least one of the following information associated with the task trigger condition: the task trigger condition itself; input information that causes the task trigger condition to be satisfied; a knowledge base associated with the task trigger condition; and known execution information of one or more work nodes in a preset workflow when the first digital assistant is associated with the preset workflow.

In some embodiments, the trigger detection module 510 includes: a function enabling determination module configured to determine whether a proactive task execution function of the first digital assistant is enabled; and an enabled detection module configured to detect whether the task trigger condition related to the first digital assistant is satisfied in response to determining that the proactive task execution function is enabled.

In some embodiments, the trigger detection module 510 includes at least one of the following: a first detection module configured to detect whether the task trigger condition is satisfied based on a first detection mode, the first detection mode including other detection modes except for the interaction with the target model; and a second detection module configured to detect whether the task trigger condition is satisfied by interacting with the target model based on a second detection mode.

In some embodiments, the first detection mode includes at least one of the following: performing a key information search on first information that includes information for detecting whether the task trigger condition is satisfied; and detecting whether the first information satisfies a preset rule.

In some embodiments, the first detection module is configured to detect whether the task trigger condition is satisfied based on the second detection mode in response to being unable to determine whether the task trigger condition is satisfied based on the first detection mode.

In some embodiments, the second detection module is configured to: obtain a second prompt based on the first information, the first information including information for detecting whether the task trigger condition is satisfied; interact with the target model based on the second prompt; and detect whether the task trigger condition is satisfied based on an interaction result with the target model.

In some embodiments, the attribute information of the first task includes at least one of the following: a type of the first task; parameter information related to the execution of the first task; and plugin information or application open interface information for executing the first task.

In some embodiments, the task trigger condition includes one or more of the following: a first user associated with the first digital assistant receives a notification message from a first service component; an event related to the first user occurs in a second service component; a preset time arrives; and execution conditions of one or more work nodes in a preset workflow are satisfied.

In some embodiments, the task execution module 520 includes at least one of the following: a first information obtaining module configured to obtain the information related to the first task based on the notification message from the first service component; a second information obtaining module configured to obtain information required for executing the first task from a service object related to the first user in at least one of the following service components: the first service component, the second service component, and at least one third service component; and a third information obtaining module configured to obtain the information related to the first task from historical interaction information of the first user.

In some embodiments, the task execution module 520 includes: an instruction sending module configured to send a message to a first user associated with the first digital assistant indicating the first user to provide additional information about the first task; an additional information receiving module configured to receive the additional information provided by the first user; and an additional execution module configured to execute the first task based on the attribute information of the first task and the additional information.

In some embodiments, the message is sent and the additional information is received in an interaction window between the first user and the first digital assistant.

In some embodiments, the execution process of the first task does not require additional input from the first user.

In some embodiments, the apparatus 500 also includes: a user input receiving module configured to receive at least one user input of the first user to the first digital assistant; and a trigger condition determination module configured to determine the task trigger condition from the at least one user input.

In some embodiments, the first digital assistant is associated with a preset workflow, and the preset workflow includes a plurality of work nodes. The trigger detection module 510 includes: a work node detection module configured to detect whether an execution condition of a respective one of the plurality of work nodes is satisfied based on at least one of the following information related to the preset workflow: the preset workflow itself, service knowledge information corresponding to the preset workflow, known execution information of one or more of the plurality of work nodes, and user feedback related to one or more of the plurality of work nodes.

In some embodiments, the work node detection module includes at least one of the following: a first detection module configured to detect, based on a first detection mode, whether the execution condition of the respective one of the plurality of work nodes is satisfied using at least one of the following: the preset workflow itself, the known execution information, and the user feedback; and a second detection module configured to interact with a target model based on a second detection mode and based on at least one of the following to detect whether the execution condition of the respective one of the plurality of work nodes is satisfied: the service knowledge information, the known execution information, and the user feedback.

In some embodiments, the task execution module 520 includes: a node task execution module configured to execute at least one task corresponding to a first work node in the preset workflow in response to detecting that the execution condition of the first work node is satisfied.

In some embodiments, the node task execution module includes: an assistant execution module configured to execute at least a part of the at least one task using the first digital assistant, and/or a task assignment module configured to assign at least a part of the at least one task to a target execution body through the first digital assistant.

In some embodiments, the apparatus 500 also includes: an information storage module configured to store respective registration information registered by at least one service component with the first digital assistant, the respective registration information of the at least one service component each including a trigger condition; and a notification sending module configured to send notification information by the first digital assistant to a first service component corresponding to the first registration information in response to detecting that a first trigger condition in first registration information is satisfied, the notification information indicating that the first trigger condition is satisfied.

In some embodiments, the apparatus 500 also includes: an execution result notification module configured to notify a first user of an execution result of the first task using the first digital assistant.

FIG. 6 illustrates a block diagram of an apparatus 600 for task processing according to some embodiments of the present disclosure. The apparatus 600 may be implemented or included in the terminal device 110, for example. Each module/component in the apparatus 600 may be implemented by hardware, software, firmware, or any combination thereof.

As shown in the figure, the apparatus 600 includes an execution condition detection module 610 configured to detect whether execution conditions of respective work nodes in a first workflow are satisfied, where the first workflow includes a plurality of work nodes. The apparatus 600 also includes a related information obtaining module 620 configured to obtain information related to a first work node in the first workflow in response to detecting that an execution condition of the first work node is satisfied. The apparatus 600 also includes a task determination module 630 configured to determine at least one task to be executed based on the information related to the first work node. The apparatus 600 also includes a task processing module 640 configured to execute at least a part of the at least one task, and/or assign at least a part of the at least one task to a target execution body.

In some embodiments, the information related to the first work node includes one or more of the following: service knowledge information corresponding to the first workflow; and known execution information corresponding to the first work node.

In some embodiments, the known execution information corresponding to the first work node includes at least: a task execution result corresponding to at least one second work node that the first work node depends on.

In some embodiments, the execution condition detection module 610 is configured to detect whether the execution condition of the respective one of the plurality of work nodes is satisfied based on at least one of the following information related to the first workflow: the first workflow itself, service knowledge information corresponding to the first workflow, known execution information of one or more of the plurality of work nodes, and user feedback related to one or more of the plurality of work nodes.

In some embodiments, the execution condition detection module 610 is configured to perform at least one of the following: detect, based on a first detection mode, whether the execution condition of the respective one of the plurality of work nodes is satisfied using at least one of the following: the first workflow itself, the known execution information, and the user feedback; and interact with a target model based on a second detection mode and based on at least one of the following to detect whether the execution condition of the respective one of the plurality of work nodes is satisfied: the service knowledge information, the known execution information, and the user feedback.

In some embodiments, the task determination module 630 is further configured to determine a prompt based on the information related to the first work node; send the prompt to the target model; and receive a result returned by the target model, the returned result containing information of the at least one task to be executed.

In some embodiments, the apparatus 600 may include a first digital assistant. At least one step performed by the apparatus 600 is performed by the first digital assistant.

In some embodiments, the at least one step performed by the first digital assistant includes: determining a prompt based on information related to the first workflow; interacting with the target model through the first digital assistant based on the prompt; and performing the at least one step based on an interaction result.

In some embodiments, the apparatus 600 also includes one or more of the following: an information sending module configured to send, by the first digital assistant, execution status information about the first workflow to the first user; and an information provision module configured to send, by the first digital assistant, a message to the first user indicating the first user to provide additional information about the first work node, and take the additional information provided by the first user as a part of the information related to the first work node.

In some embodiments, the apparatus 600 also includes: an operation receiving module configured to receive a configuration operation of the first user on the first digital assistant, the configuration operation including one or more of the following: associating the first workflow with the first digital assistant; and associating the service knowledge information corresponding to the first workflow with the first digital assistant.

In some embodiments, the task processing module 640 is further configured to: send a notification message to a user associated with the at least one task, the notification message indicating at least a part of the at least one task; and send at least a part of the at least one task to a target service component or a second digital assistant.

In some embodiments, the first workflow includes a standard operating procedure (SOP) of a first service.

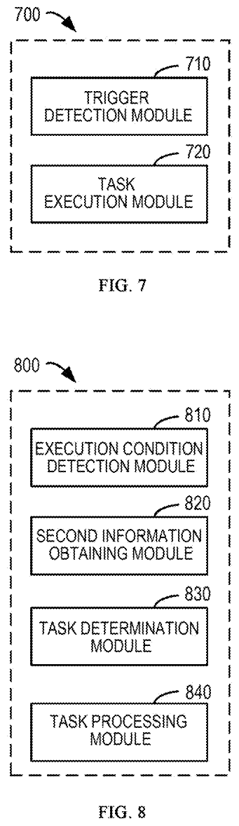

FIG. 7 illustrates a block diagram of an apparatus 700 for task processing according to some embodiments of the present disclosure. The apparatus 700 may be implemented or included in the terminal device 110, for example. Each module/component in the apparatus 700 may be implemented by hardware, software, firmware, or any combination thereof.

As shown in the figure, the apparatus 700 includes a trigger detection module 710 configured to detect whether a task trigger condition related to a first digital assistant is satisfied. The apparatus 700 also includes a task execution module 720 configured to initiate task execution related to the first digital assistant in response to the task trigger condition being satisfied. The task execution includes: obtaining information related to a first task; and performing, by interacting with a target model, at least one of the following based on the obtained information related to the first task: obtaining attribute information of the first task; and executing the first task based on the attribute information of the first task.

In some embodiments, the task execution module 720 includes: a first prompt sending module configured to send, to the target model, a first prompt acquired based on the information related to the first task; and obtain a feedback from the target model; and an attribute determination module configured to determine the attribute information of the first task based on the feedback.

In some embodiments, the task execution module 720 is configured to obtain the information related to the first task based on at least one of the following information associated with the task trigger condition: the task trigger condition itself; input information that causes the task trigger condition to be satisfied; a knowledge base associated with the task trigger condition; and known execution information of one or more work nodes in the preset workflow if the first digital assistant is associated with the preset workflow.

In some embodiments, the trigger detection module 710 includes: a function enablement determination module configured to determine whether an active task execution function of the first digital assistant is enabled; and a post-enablement detection module configured to detect whether the task trigger condition related to the first digital assistant is satisfied in response to determining that the active task execution function is enabled.

In some embodiments, the trigger detection module 710 includes at least one of the following: a first detection module configured to detect whether the task trigger condition is satisfied based on a first detection mode that includes a detection mode other than the interaction with the target model; and a second detection module configured to detect whether the task trigger condition is satisfied by interacting with the target model based on a second detection mode.

In some embodiments, the first detection mode includes at least one of the following: performing a key information search for first information that includes information for detecting whether the task trigger condition is satisfied; and detecting whether the first information satisfies a preset rule.

In some embodiments, the first detection module is configured to detect whether the task trigger condition is satisfied based on the second detection mode in response to failing to determine whether the task trigger condition is satisfied based on the first detection mode.

In some embodiments, the second detection module is configured to: acquire a second prompt based on the first information that includes information for detecting whether the task trigger condition is satisfied; interact with the target model based on the second prompt; and detect whether the task trigger condition is satisfied based on an interaction result with the target model.

In some embodiments, the attribute information of the first task includes at least one of the following: a type of the first task; parameter information related to the execution of the first task; and plugin information or application program open interface information for executing the first task.

In some embodiments, the task trigger condition includes one or more of the following: a first user associated with the first digital assistant receives a notification message from a first service component; an event related to the first user occurs in a second service component; a preset time is reached; and an execution condition of one or more work nodes in a preset workflow is satisfied.

In some embodiments, the task execution module 720 includes at least one of the following: a first information obtaining module configured to obtain the information related to the first task based on the notification message from the first service component; a second information obtaining module configured to obtain information required for executing the first task from a service object related to the first user in at least one of the following service components: the first service component, the second service component, and at least one third service component; and a third information obtaining module configured to obtain the information related to the first task from historical interaction information of the first user.

In some embodiments, the task execution module 720 includes: an instruction occurrence module configured to send a message to a first user associated with the first digital assistant to instruct the first user to provide additional information about the first task; an additional information receiving module configured to receive the additional information provided by the first user; and an additional execution module configured to execute the first task based on the attribute information of the first task and the additional information.

In some embodiments, the message is sent and the additional information is received within an interaction window between the first user and the first digital assistant.

In some embodiments, the execution process of the first task does not require additional input from the first user.

In some embodiments, the apparatus 700 also includes: a user input receiving module configured to receive at least one user input from the first user on the first digital assistant; and a trigger condition determination module configured to determine the task trigger condition from the at least one user input.

In some embodiments, the first digital assistant is associated with a preset workflow, and the preset workflow includes a plurality of work nodes. The trigger detection module 710 includes a work node detection module configured to detect whether an execution condition of each of the plurality of work nodes is satisfied based on at least one of the following information related to the preset workflow: the preset workflow itself, service knowledge information corresponding to the preset workflow, known execution information of one or more work nodes in the plurality of work nodes, and user feedback related to the one or more work nodes in the plurality of work nodes.

In some embodiments, the work node detection module includes at least one of the following: a first detection module configured to detect, based on a first detection mode, whether the execution condition of each of the plurality of work nodes is satisfied by using at least one of the following: the preset workflow itself, the known execution information, and the user feedback; and a second detection module configured to interact with a target model based on a second detection mode and based on at least one of the following to detect whether the execution condition of each of the plurality of work nodes is satisfied: the service knowledge information, the known execution information, and the user feedback.

In some embodiments, the task execution module 720 includes a node task execution module configured to execute at least one task corresponding to a first work node in the preset workflow in response to detecting that an execution condition of the first work node is satisfied.

In some embodiments, the node task execution module includes: an assistant execution module configured to execute at least a portion of the at least one task by the first digital assistant, and/or a task assignment module configured to assign at least a portion of the at least one task to a target execution body through the first digital assistant.

In some embodiments, the apparatus 700 also includes: an information storage module configured to store corresponding registration information registered by at least one service component with the first digital assistant, the corresponding registration information of the at least one service component respectively including a trigger condition; and a notification sending module configured to send notification information by the first digital assistant to a first service component corresponding to the first registration information in response to detecting that a first trigger condition in first registration information is satisfied, the notification information indicating that the first trigger condition is satisfied.

In some embodiments, the apparatus 700 also includes an execution result notification module configured to notify a first user of an execution result of the first task by the first digital assistant.

FIG. 8 illustrates a block diagram of an apparatus 800 for task processing according to some embodiments of the present disclosure. The apparatus 800 may be implemented or included in the terminal device 110, for example. Each module/component in the apparatus 800 may be implemented by hardware, software, firmware, or any combination thereof.

As shown in the figure, the apparatus 800 includes an execution condition detection module 810 configured to detect whether an execution condition of each work node in a first workflow is satisfied, the first workflow including a plurality of work nodes. The apparatus 800 also includes a second information obtaining module 820 configured to obtain information related to a first work node in the first workflow in response to detecting that an execution condition of the first work node is satisfied. The apparatus 800 also includes a task determination module 830 configured to determine at least one task to be executed based on the information related to the first work node. The apparatus 800 also includes a task processing module 840 configured to execute at least a portion of the at least one task, and/or assign at least a portion of the at least one task to a target execution body.

In some embodiments, the information related to the first work node includes one or more of the following: service knowledge information corresponding to the first workflow; and known execution information corresponding to the first work node.

In some embodiments, the known execution information corresponding to the first work node includes at least a task execution result corresponding to at least one second work node on which the first work node depends.

In some embodiments, the execution condition detection module 810 is configured to detect whether the execution condition of each of the plurality of work nodes is satisfied based on at least one of the following information related to the first workflow: the first workflow itself, service knowledge information corresponding to the first workflow, known execution information of one or more work nodes in the plurality of work nodes, and user feedback related to the one or more work nodes in the plurality of work nodes.

In some embodiments, the execution condition detection module 810 is configured to perform at least one of the following: detecting, based on a first detection mode, whether the execution condition of each of the plurality of work nodes is satisfied by using at least one of the following: the first workflow itself, the known execution information, and the user feedback; and interacting with a target model based on a second detection mode and based on at least one of the following to detect whether the execution condition of each of the plurality of work nodes is satisfied: the service knowledge information, the known execution information, and the user feedback.

In some embodiments, the task determination module 830 is further configured to: determine a prompt based on the information related to the first work node; send the prompt to the target model; and receive a result returned by the target model, the returned result containing information of the at least one task to be executed.

In some embodiments, the apparatus 800 may include the first digital assistant.

In some embodiments, the apparatus 800 also includes one or more of the following: a first information sending module configured to send, by the first digital assistant, execution information about the first workflow to a first user; and an information provision module configured to send, by the first digital assistant, a message to the first user to instruct the first user to provide additional information about the first work node, and use the additional information provided by the first user as a part of the information related to the first work node.

In some embodiments, the apparatus 800 also includes an operation receiving module configured to receive a configuration operation from the first user on the first digital assistant, the configuration operation including one or more of the following: associating the first workflow with the first digital assistant; and associating the service knowledge information corresponding to the first workflow with the first digital assistant.

In some embodiments, the task processing module 840 is further configured to: send a notification message to a user associated with the at least one task, the notification message indicating at least a portion of the at least one task; and send at least a portion of the at least one task to a target application or a second digital assistant.

In some embodiments, the first workflow includes a standard operating procedure (SOP) for a first service.

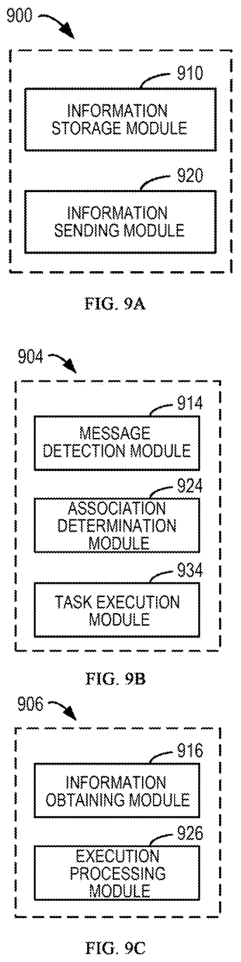

FIG. 9A illustrates a block diagram of an apparatus 900 for task processing according to some embodiments of the present disclosure. The apparatus 900 may be implemented or included in the terminal device 110, for example. Each module/component in the apparatus 900 may be implemented by hardware, software, firmware, or any combination thereof.

As shown in the figure, the apparatus 900 includes an information storage module 910 configured to store corresponding registration information registered by at least one service component with a first digital assistant, the corresponding registration information of the at least one service component respectively including a trigger condition. The apparatus 900 also includes an information sending module 920 configured to send notification information by the first digital assistant to a first service component corresponding to the first registration information, in response to detecting that a first trigger condition in first registration information is satisfied, the notification information indicating that the first trigger condition is satisfied.

In some embodiments, the apparatus 900 also includes a first information sending module configured to send contextual information related to the first trigger condition by the first digital assistant to the first service component in response to detecting that the first trigger condition is satisfied.

In some embodiments, the first digital assistant corresponds to one or more users, and the trigger condition included in the corresponding registration information of the at least one service component is associated with the one or more users.

In some embodiments, the information storage module 910 is further configured to: receive at least one user input from a first user on the first digital assistant; determine a second trigger condition of a task to be executed by a second service component in the at least one service component from the at least one user input; and store second registration information of the second service component in response to the determination of the second trigger condition, the second registration information including the second trigger condition.

In some embodiments, the information storage module 910 is further configured to: receive third registration information from a third service component in the at least one service component, the third registration information including a third trigger condition; and store the received third registration information.

In some embodiments, the third trigger condition is determined by the third service component based on at least one of the following: an execution condition of the task for which the third trigger condition is used, or an interaction between the first user and the third service component.

In some embodiments, the information storage module 910 is further configured to: receive interaction information between the first user and a fourth service component from the fourth service component in the at least one service component; determine a fourth trigger condition of a task to be executed for the fourth service component from the interaction information; and store fourth registration information of the fourth service component in response to the determination of the fourth trigger condition, the fourth registration information including the fourth trigger condition.

In some embodiments, the apparatus 900 also includes: a detection module configured to, for a fifth trigger condition corresponding to a fifth service component, determine an object to be accessed to detect whether the fifth trigger condition is satisfied; a permission determination module configured to determine whether the fifth service component has the permission to access the object; and a prohibition module configured to prohibit the fifth service component from registering the fifth trigger condition with the first digital assistant in response to the fifth service component not having the permission to access.

In some embodiments, the first trigger condition includes at least one of the following: a user associated with the first digital assistant receives a notification message from the first service component; an event related to the user occurs in the first service component or a second service component; a preset time is reached; and an execution condition of one or more work nodes in a preset workflow is satisfied.

In some embodiments, the one or more service components in the at least one service component include a digital assistant.

FIG. 9B illustrates a block diagram of an apparatus 904 for task processing according to some embodiments of the present disclosure. The apparatus 904 may be implemented or included in the terminal device 110, for example. Each module/component in the apparatus 904 may be implemented by hardware, software, firmware, or any combination thereof.

As shown in the figure, the apparatus 904 includes a message detection module 914 configured to detect a first message sent by a first digital assistant corresponding to at least a first user, the first message indicating a target task. The apparatus 904 also includes an association determination module 924 configured to determine an association between the target task indicated by the first message and a second user. The apparatus 904 also includes a task execution module 934 configured to execute at least a portion of the target task by a second digital assistant corresponding to the second user based on the first message in response to determining that the target task is associated with the second user.

In some embodiments, the message detection module 914 is further configured to receive a chat message from the first digital assistant in a group chat, the group chat including at least the first digital assistant, the first user, and the second user.

In some embodiments, the first digital assistant corresponds to multiple users including the first user, and the second user is one of the multiple users.

In some embodiments, the association determination module 924 is further configured to determine the association between the target task and the second user based on content or an attribute of the first message.

In some embodiments, the association determination module 924 is further configured to: determine that the target task is associated with the second user in response to the first message including a mention symbol for the second user or the second digital assistant, determine that the target task is associated with the second user in response to the first message being an announcement message of a group chat including the second user or the second digital assistant, or determine that the target task is associated with the second user in response to the first message being sent to a group including the second user.

In some embodiments, the association determination module 924 is further configured to determine that the target task is associated with the second user in response to determining that the first digital assistant and the second digital assistant have an association relationship for the target task.

In some embodiments, the apparatus 904 also includes: a task determination module configured to determine the target task by the first digital assistant based on at least one of the following: at least one chat message in the group chat or a workflow associated with the group chat; and a message sending module configured to send the first message indicating the target task in the group chat by the first digital assistant.

In some embodiments, the apparatus 904 also includes an association setting module configured to set content or an attribute of the first message to indicate that the target task is associated with the second user in response to the first digital assistant and the second digital assistant having an association relationship for the target task.

In some embodiments, the association relationship includes at least one of the following: the first digital assistant and the second digital assistant belong to a workflow including the target task, or the second digital assistant sends a trigger request for one or more tasks to the first digital assistant, the one or more tasks including the target task.

FIG. 9C illustrates a block diagram of an apparatus 906 for task processing according to some embodiments of the present disclosure. The apparatus 906 may be implemented or included in the terminal device 110, for example. Each module/component in the apparatus 906 may be implemented by hardware, software, firmware, or any combination thereof.

As shown in the figure, the apparatus 906 includes an information obtaining module 916 configured to cause a second digital assistant to obtain first event information triggered by a first digital assistant. The apparatus 906 also includes an execution processing module 926 configured to cause the second digital assistant to execute a first task and output first information related to the first task based on the first event information.

In some embodiments, one or more of the following are satisfied: the second digital assistant and the first digital assistant are in the same service entity; the second digital assistant pays attention to the first digital assistant; and the second digital assistant subscribes to at least some functions of the first digital assistant.

In some embodiments, the second digital assistant is a digital assistant associated with a second user, and the second digital assistant outputs the first information related to the first task to the second user.

In some embodiments, the first digital assistant is a digital assistant associated with a first user; or, the first digital assistant is a digital assistant of the first service component.

It should be understood that the above apparatus 500, apparatus 600, apparatus 700, apparatus 800, apparatus 900, apparatus 904 and/or apparatus 906 may be implemented in a same apparatus or device. One or more steps in the processes discussed above may be performed by a suitable electronic device or a combination of electronic devices. Such an electronic device or a combination of electronic devices may include, for example, the server 130, the terminal device 110, and/or a combination of the server 130 and the terminal device 110 in FIG. 1.

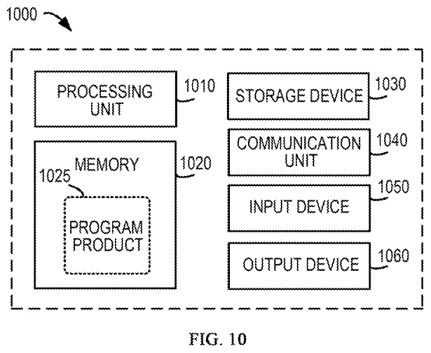

FIG. 10 illustrates a block diagram of an electronic device 1000 in which one or more embodiments of the present disclosure may be implemented. It should be understood that the electronic device 1000 shown in FIG. 10 is only illustrative, and should not constitute any limitation on the functions and scope of the embodiments described herein. The electronic device 1000 shown in FIG. 10 may be used to implement the terminal device 110 and/or the server 130 in FIG. 1, the apparatus 500, the apparatus 600, the apparatus 700, the apparatus 800, the apparatus 900, the apparatus 904 and/or the apparatus 906 shown in FIG. 5 to FIG. 9C.

As shown in FIG. 10, the electronic device 1000 is in a form of a general-purpose electronic device. Components of the electronic device 1000 may include, but are not limited to, one or more processors or processing units 1010, a memory 1020, a storage device 1030, one or more communication units 1040, one or more input devices 1050, and one or more output devices 1060. The processing unit 1010 may be an actual or virtual processor, and may perform various processing based on a program stored in the memory 1020. In a multi-processor system, multiple processing units execute computer-executable instructions in parallel to improve the parallel processing capability of the electronic device 1000.

The electronic device 1000 typically includes multiple computer storage medium. Such medium may be any available medium that is accessible to the electronic device 1000, including, but not limited to, volatile and non-volatile medium, removable and non-removable medium. The memory 1020 may be volatile memory (for example, a register, cache, a random access memory (RAM)), a non-volatile memory (such as a read-only memory (ROM), an electrically erasable programmable read-only memory (EEPROM), a flash memory), or any combination thereof. The storage device 1030 may be any removable or non-removable medium, and may include a machine-readable medium such as a flash drive, a disk, or any other medium, which may be used to store information and/or data and may be accessed within the electronic device 1000.

The electronic device 1000 may further include additional removable/non-removable, volatile/non-volatile memory medium. Although not shown in FIG. 10, a disk driver for reading from or writing into removable and non-volatile disks (such as a “floppy disk”), and an optical disk driver for reading from or writing into removable and non-volatile optical disks may be provided. In these cases, each driver may be connected to the bus (not shown) by one or more data medium interfaces. The memory 1020 may include a computer program product 1025, which has one or more program modules configured to perform various methods or acts of various embodiments of the present disclosure.

The communication unit 1040 implements communication with other electronic devices through the communication medium. Additionally, the functions of the components of the electronic device 1000 may be implemented by a single computing cluster or multiple computing machines, which may communicate through communication connections. Therefore, the electronic device 1000 may use a logical connection with one or more other servers, a network personal computer (PC) or another network node to operate in a networked environment.

The input device 1050 may be one or more input devices, such as a mouse, a keyboard, a tracking ball, etc. The output device 1060 may be one or more output devices, such as a display, a speaker, a printer, etc. The electronic device 1000 may also communicate with one or more external devices (not shown) as needed through the communication unit 1040, such as a storage device, a display device, etc., communicate with one or more devices that enable the user to interact with the electronic device 1000, or communicate with any device (such as a network card, a modem, etc.) that enables the electronic device 1000 to communicate with one or more other electronic devices. Such communication may be performed via input/output (I/O) interfaces (not shown).

According to an example implementation of the present disclosure, there is provided a computer-readable storage medium having computer-executable instructions stored thereon, the computer-executable instructions being executed by a processor to implement the method described above. According to an example implementation of the present disclosure, there is also provided a computer program product, the computer program product being tangibly stored on a non-transitory computer-readable medium and including computer-executable instructions, the computer-executable instructions being executed by a processor to implement the method described above.

Various aspects of the present disclosure are described herein with reference to flowcharts and/or block diagrams of methods, apparatuses, devices and computer program products implemented according to the present disclosure. It should be understood that each block of the flowchart and/or block diagram, and a combination of each block in the flowchart and/or block diagram, may be implemented by computer-readable program instructions.

These computer-readable program instructions may be provided to a processing unit of a general-purpose computer, a special-purpose computer or other programmable data processing apparatus, so as to produce a machine, such that the instructions, when executed by the processing unit of the computer or other programmable data processing apparatus, produce an apparatus for implementing a function/act specified in one or more blocks of the flowchart and/or block diagram. These computer-readable program instructions may also be stored in a computer-readable storage medium, these instructions enable the computer, the programmable data processing apparatus and/or other devices to work in a specific way, so that the computer-readable medium having the instructions stored thereon includes a manufactured product, which includes instructions for implementing various aspects of the function/act specified in one or more blocks of the flowchart and/or block diagram.

The computer-readable program instructions may be loaded onto a computer, other programmable data processing apparatus or other devices, so that a series of operations and steps are executed on the computer, other programmable data processing apparatus or other devices, to generate a computer-implemented process, so that the instructions executed on the computer, other programmable data processing apparatus or other devices implement the function/act specified in one or more blocks of the flowchart and/or block diagram.

The flowchart and block diagram in the drawings show the possibly implemented architectures, functions and operations of the system, method and computer program product according to multiple implementations of the present disclosure. In this regard, each block in the flowchart or block diagram may represent a module, program segment or part of an instruction, the module, program segment or part of the instruction contains one or more executable instructions for implementing the specified logical function. In some alternative implementations, the functions marked in the blocks may also occur in an order different from that marked in the drawings. For example, two consecutive blocks may actually be executed substantially in parallel, or they may sometimes be executed in the reverse order, depending on the functions involved. It should also be noted that each block in the block diagram and/or flowchart, and a combination of blocks in the block diagram and/or flowchart, may be implemented by a dedicated hardware-based system that executes a specified function or act, or may be implemented by a combination of dedicated hardware and computer instructions.

The implementations of the present disclosure have been described above, and the above description is illustrative, not exhaustive, and is not limited to the disclosed implementations. Many modifications and changes will be apparent to those of ordinary skill in the art without departing from the scope and spirit of the described implementations. The terms used herein are chosen to best explain the principles of the implementations, the practical applications, or improvements to the technologies in the market, or to enable other those of ordinary skill in the art to understand the implementations disclosed herein.

1. A method for task processing, comprising:
detecting whether execution conditions of respective work nodes in a first workflow are satisfied, wherein the first workflow comprises a plurality of work nodes;
obtaining information related to a first work node in the first workflow in response to detecting that an execution condition of the first work node is satisfied;
determining at least one task to be executed based on the information related to the first work node; and
executing at least a part of the at least one task, and/or assigning at least a part of the at least one task to an execution body.

2. The method of claim 1, wherein the information related to the first work node comprises one or more of the following:
service knowledge information corresponding to the first workflow;
known execution information corresponding to the first work node,
wherein the known execution information corresponding to the first work node comprises at least:
a task execution result corresponding to at least one second work node that the first work node depends on.

3. The method of claim 1, wherein detecting whether the execution conditions of the respective work nodes in the first workflow are satisfied comprises
detecting whether an execution condition of a respective one of the plurality of work nodes is satisfied based on at least one of the following information related to the first workflow:
the first workflow itself,
service knowledge information corresponding to the first workflow,
known execution information of one or more of the plurality of work nodes,
user feedback related to one or more of the plurality of work nodes, and
wherein detecting whether the execution condition of the respective one of the plurality of work nodes is satisfied comprises at least one of the following:
detecting, based on a first detection mode, that the execution condition of the respective one of the plurality of work nodes is satisfied by using at least one of the following: the first workflow itself, the known execution information, the user feedback;
interacting with a model based on a second detection mode and based on at least one of the following to detect that the execution condition of the respective one of the plurality of work nodes is satisfied: the service knowledge information, the known execution information, the user feedback.

4. The method of claim 1, wherein determining the at least one task to be executed based on the information related to the first work node comprises:
determining a prompt based on the information related to the first work node;
sending the prompt to a model; and
receiving a result returned by the model, the returned result containing information of the at least one task to be executed.

5. The method of claim 1, wherein at least one of steps in the method is performed by a first digital assistant, and the at least one of the steps of the method performed by the first digital assistant comprises:
determining a prompt based on the information related to the first workflow;
interacting with a model through the first digital assistant based on the prompt; and
performing the at least one step based on an interaction result.

6. The method of claim 1, wherein at least one of steps in the method is performed by a first digital assistant, and the method further comprises one or more of the following:
sending, by the first digital assistant to a first user, execution status information about the first workflow;
sending, by the first digital assistant to the first user, a message instructing the first user to provide additional information about the first work node, and using the additional information provided by the first user as a part of the information related to the first work node.

7. The method of claim 1, wherein at least one of steps in the method is performed by a first digital assistant, and the method further comprises:
receiving a configuration operation of a first user on the first digital assistant, the configuration operation comprising one or more of the following:
associating the first workflow with the first digital assistant; and
associating service knowledge information corresponding to the first workflow with the first digital assistant.

8. The method of claim 1, wherein assigning at least a part of the at least one task to the execution body comprises at least one of the following:
sending a notification message to a user associated with the at least one task, the notification message indicating at least a part of the at least one task;
sending at least a part of the at least one task to a target service component or a second digital assistant.

9. A method for task processing, comprising:
detecting whether a task trigger condition related to a first digital assistant is satisfied; and
initiating task execution related to the first digital assistant in response to the task trigger condition being satisfied, wherein the task execution comprises:
obtaining information related to a first task;
performing, by interacting with a model, at least one of the following based on the obtained information related to the first task:
obtaining attribute information of the first task;
executing the first task based on the attribute information of the first task.

10. The method of claim 9, wherein obtaining the attribute information of the first task by interacting with the model based on the obtained information related to the first task comprises:
sending, to the model, a first prompt acquired based on the information related to the first task;
obtaining a feedback from the model; and
determining the attribute information of the first task based on the feedback.

11. The method of claim 9, wherein obtaining the information related to the first task comprises:
obtaining the information related to the first task based on at least one of the following information associated with the task trigger condition:
the task trigger condition itself;
input information that causes the task trigger condition to be satisfied;
a knowledge base associated with the task trigger condition; and
known execution information of one or more work nodes in a preset workflow if the first digital assistant is associated with the preset workflow.

12. The method of claim 9, wherein detecting whether the task trigger condition related to the first digital assistant is satisfied comprises:
determining whether an active task execution function of the first digital assistant is enabled; and
detecting whether the task trigger condition related to the first digital assistant is satisfied in response to determining that the active task execution function is enabled.

13. The method of claim 9, wherein detecting whether the task trigger condition related to the first digital assistant is satisfied comprises at least one of the following:
detecting whether the task trigger condition is satisfied based on a first detection mode that comprises a detection mode other than an interaction with the model; and
detecting whether the task trigger condition is satisfied by interacting with the model based on a second detection mode, and
wherein the first detection mode comprises at least one of the following:
performing a key information search for first information that comprises information for detecting whether the task trigger condition is satisfied; and
detecting whether the first information satisfies a preset rule.

14. The method of claim 9, wherein detecting whether the task trigger condition related to the first digital assistant is satisfied comprises at least one of the following:
detecting whether the task trigger condition is satisfied based on a first detection mode that comprises a detection mode other than an interaction with the model; and
detecting whether the task trigger condition is satisfied by interacting with the model based on a second detection mode, and
wherein detecting whether the task trigger condition related to the first digital assistant is satisfied comprises:
detecting whether the task trigger condition is satisfied based on the second detection mode in response to failing to determine whether the task trigger condition is satisfied based on the first detection mode.

15. The method of claim 9, wherein detecting whether the task trigger condition related to the first digital assistant is satisfied comprises at least one of the following:
detecting whether the task trigger condition is satisfied based on a first detection mode that comprises a detection mode other than an interaction with the model; and
detecting whether the task trigger condition is satisfied by interacting with the model based on a second detection mode, and
wherein detecting whether the task trigger condition is satisfied by interacting with the model based on the second detection mode comprises:
acquiring a second prompt based on first information that comprises information for detecting whether the task trigger condition is satisfied;
interacting with the model based on the second prompt; and
detecting whether the task trigger condition is satisfied based on an interaction result with the model.

16. The method of claim 9, wherein the task trigger condition comprises one or more of the following:
a first user associated with the first digital assistant receives a notification message from a first service component;
an event related to the first user occurs in a second service component;
a preset time is reached;
an execution condition of one or more work nodes in a preset workflow is satisfied, wherein obtaining the information related to the first task comprises at least one of the following:
obtaining the information related to the first task based on the notification message from the first service component;
obtaining information required for executing the first task from a service object related to the first user in at least one of the following service components: the first service component, the second service component, at least one third service component;
obtaining the information related to the first task from historical interaction information of the first user.

17. The method of claim 9, wherein executing the first task comprises:
sending, to a first user associated with the first digital assistant, a message for instructing the first user to provide additional information about the first task;
receiving the additional information provided by the first user; and
executing the first task based on the information related to the first task and the additional information,
wherein the message is sent and the additional information is received within an interaction window between the first user and the first digital assistant.

18. The method of claim 9, wherein the first digital assistant is associated with a preset workflow, the preset workflow comprises a plurality of work nodes, and wherein detecting whether the task trigger condition related to the first digital assistant is satisfied comprises:
detecting whether an execution condition of a respective one of the plurality of work nodes is satisfied based on at least one of the following information related to the preset workflow:
the preset workflow itself,
service knowledge information corresponding to the preset workflow,
known execution information of one or more work nodes in the plurality of work nodes,
user feedback related to one or more work nodes in the plurality of work nodes,
wherein detecting whether the execution condition of the respective one of the plurality of work nodes is satisfied comprises at least one of the following:
detecting, based on a first detection mode, whether the execution condition of the respective one of the plurality of work nodes is satisfied by using at least one of the following: the preset workflow itself, the known execution information, the user feedback; or
interacting with the model based on a second detection mode and based on at least one of the following to detect whether the execution condition of the respective one of the plurality of work nodes is satisfied: the service knowledge information, the known execution information, the user feedback.

19. An electronic device, comprising:
at least one processor; and
at least one memory coupled to the at least one processor, and storing instructions executable by the at least one processor, wherein the instructions, when executed by the at least one processor, cause the electronic device to perform operations comprising:
detecting whether execution conditions of respective work nodes in a first workflow are satisfied, wherein the first workflow comprises a plurality of work nodes;
obtaining information related to a first work node in the first workflow in response to detecting that an execution condition of the first work node is satisfied;
determining at least one task to be executed based on the information related to the first work node; and
executing at least a part of the at least one task, and/or assigning at least a part of the at least one task to an execution body.

20. An electronic device, comprising:
at least one processor; and
at least one memory coupled to the at least one processor, and storing instructions executable by the at least one processor, wherein the instructions, when executed by the at least one processor, cause the electronic device to perform operations comprising:
detecting whether a task trigger condition related to a first digital assistant is satisfied; and
initiating task execution related to the first digital assistant in response to the task trigger condition being satisfied, wherein the task execution comprises:
obtaining information related to a first task;
performing, by interacting with a model, at least one of the following based on the obtained information related to the first task:
obtaining attribute information of the first task;
executing the first task based on the attribute information of the first task.
